(19) United States
(12) Patent Application Publication
(10) Pub. No.: US 2005/0273315 A1
(43) Pub. Date: Dec. 8, 2005

(54) Method for developing a translator and a corresponding system

(76) Inventor: Erkki Laitila, Jyvaskyla (FI)

Correspondence Address: Fildes & Outland, 20916 Mack Avenue, Suite 2, Grosse Pointe Woods, MI, 48236, US

(21) Appl. No.: 10/478,041

(22) PCT Filed: May 15, 2002
(86) PCT No.: PCT/FI02/00411

§ 371 Date: Sep. 13, 2004

(30) Foreign Application Priority Data
May 15, 2001 (FI) 20011015

(51) Int. Cl. G06F 17/27

(52) U.S. Cl. 704/9

(57) ABSTRACT

The invention relates to a method for developing a translator and a corresponding system, which translator is intended to translate the code of an input language into that of a target language. In the method, a descriptive language (V) is used to depict on a semantic level two source languages that are independent of each other, that is, the said input language (X) and a target language (Y) and conversion instructions are prepared using this descriptive language. The corresponding system includes the translator and accessory files, which convert the input language first of all into the semantic descriptive language (VX), which is converted to the target language converted to the descriptive language (VY), from which the target language code is finally generated. In this way, the conversion instruction is as small as possible.

The present invention relates to a method for developing a translator and a corresponding system, which is intended for converting an input language code into a target language. In the method, a descriptive language (V) is used to formally describe two source languages independent of each other, i.e. a so-called input language (X) and a so-called target language (Y), each source language consisting of formal terms (Xi, Yⱼ), with one or several occurrences in each master term, and possible parameters in these. A program framework is created for the translator, along with a group of files, which are linked together and translated for the selected operating system.

Every formal language, including all programming language and formal specification languages, can be defined with the aid of its clauses, i.e. structures, in such a way that the possible clause types and possible sub-clause types of each clause are defined, as well as the external appearance of the language (syntax), which contains the keywords and defines the fixed order of words and terms. Each term can be a reserved word, such as an indivisible term M, or a conceptual type (C), or a divisible term (N), which is a higher component and is constructed from other types. The higher terms are called starting symbols (S). Each term type has a name, a production (P), i.e. a master term. The production can be either a list (L), a divisible term (N), an indivisible term (T), or a certain type (C). Formal grammar is a combination of all of these (S, P, T, N, C, L). An entire grammar can be formed, starting from the starting symbols using a typical tree run-through routine, which ends in indivisible terms, which are the leaf nodes.

Translation between languages can be described as follows. The code is read using a scanner operation, which divides the code into key terms (token list). A parser operation is used to group the key terms to form a parser tree, which is then parsed to give individual terms, for the processing of which specific rules are created. In known conversion processes from one language to another, the basic terms, i.e. keywords, are found either from the glossary of the language (reserved words), or from its libraries. The statements of a formal language are typically divided into consecutive structures, control structures, selection structures, and data structures. Consecutive structures are converted directly and the correspondences for them are developed one clause and term at a time. Control structure conversions into a higher-level language are simple, as the correspondence can be developed directly, or with a small amount of alteration. Control structure conversion into a lower-level language demands manual examination in cases using structures not found in the new language. For example, converting C's for-loop into Pascal's for-loop will not succeed as such, if there are operations other than those relating to basic incrementation or decrementation in the control components (incrementation, terminal component). Thus, it is best to define the Pascal correspondence as, for example, a ‘REPEAT-UNTIL’ loop, suitably supplemented. The selection structures of different languages resemble each another. The data structures are made compatible using libraries and defined function calls, or macros. When dealing with a dynamic memory, function correspondences are formed between the languages.

The known way to make translators is based on the Abstract syntax tree principle (AST), or the Object Framework principle (OF), or a meta-language. AST contains the target-language grammar, specific program structures, and a rule presentation form, by means of which the input language is converted into the target language. In the OF principle, objects and classes, in which code for the new language and its terms are written, are created to correspond to the terms of the input language. In the OF's classes there is also code, which performs the parsing operation of the relevant class distributedly. In the methods referred to above, the connection between the languages takes place as a syntax tree. Known methods are disclosed in, for example, the following patents: EP 0371943, U.S. Pat. No. 5,768,564 and U.S. Pat. No. 4,980,829 and U.S. Pat. No. 4,729,096, and GB 2327786. All the known translators result in rather cumbersome applications. When translating the same language to several other languages it has sometimes been possible to reduce the amount of input-language processing. In the system according to the aforementioned EP publication, objects according to the target language are made from the input language. Several files containing semantic and code-generator portions, which the user must form, are combined with these. The system then forms the input file directly into target-language code.

The present invention is intended to create a simpler method for developing a translator and a system for implementing the translator. The characteristic features of the method according to the invention are stated in the accompanying Claim 1 and the characteristic features of the corresponding translator system are stated in Claim 6. According to the method, the structure of both languages in described as a grammar, while at the same time a suitable semantic name, corresponding to the syntax structure, is chosen for each term. The conversion is made on a semantic level, in such a way that inessential syntax information is removed from both source languages, by forming descriptive language versions of them. At the same time, the necessary accessory files for the translator can be formed from the information obtained and from the source language, so that the translator developed forms a parsing tree in the said descriptive language, which can now be converted using a minimum of knowledge. Similarly, the formation of such a conversion instruction for each source-language term and its presentation requires much less work than when using known translators. The making of the descriptive language version is a straightforward operation and preferably takes place already when entering the grammar. With the aid of these operations and of the formal original grammars the accessory files used by the translator are created automatically.

The invention has the following advantages:
The application of the method between several languages, particularly from one language to several languages, gains the considerable advantage that the input language needs to be converted only once into the descriptive language.
The translator itself forms a relatively light program while the conversion instruction file used by it is the smallest possible. As stated above, the accessory files increase the amount of information to some extent, but they are relatively directly constructed lists. The method according to the invention provides an opportunity to test the method by converting the program code translated to the intermediate language back to the input language.
Instead of a programming language, the source language can also be a documentation language, particularly the XML format. This permits automatic documentation. The source language is a documentation format of a selected form, (e.g. module print-out, variable list, cross-reference table, graphical hierarchal diagram, data-flow diagram).

In the following, the invention is examined with the aid of an example, which is shown in the accompanying figures and in the code print-out. The example depicts the development of a translator from the simple Minilan language to the C language. The grammar of the Minilan language is described on page 12, the necessary samples of the C language appearing on page 19.

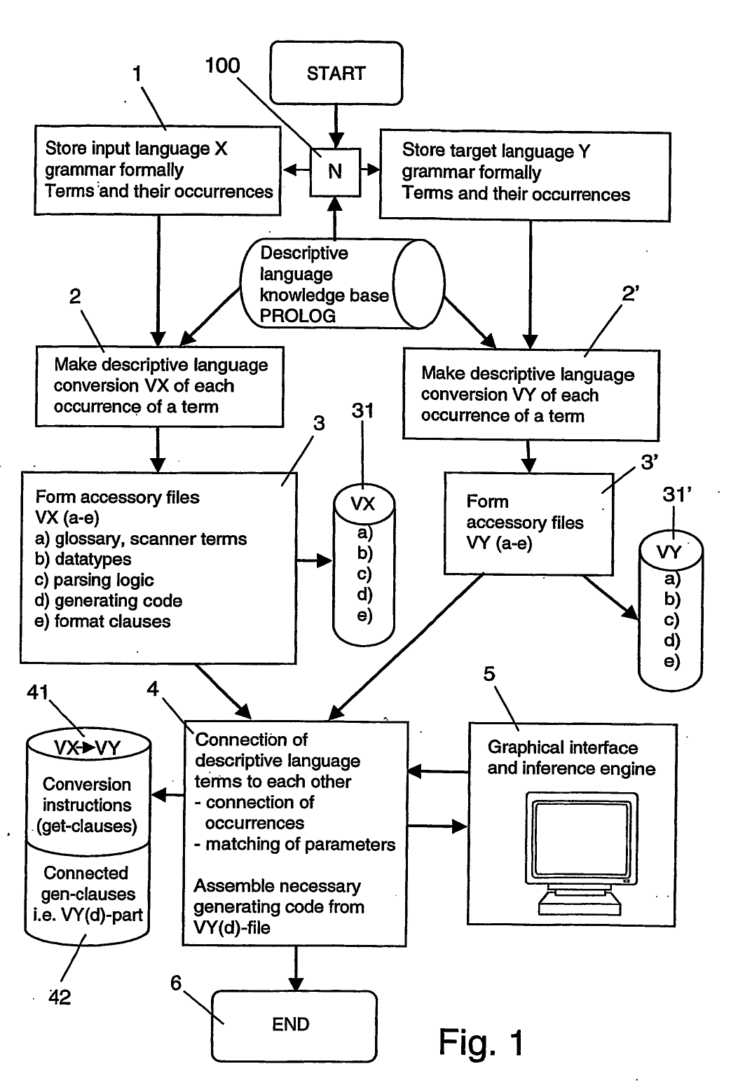

FIG. 1 shows a flow diagram of the method according to the invention for developing a translator.

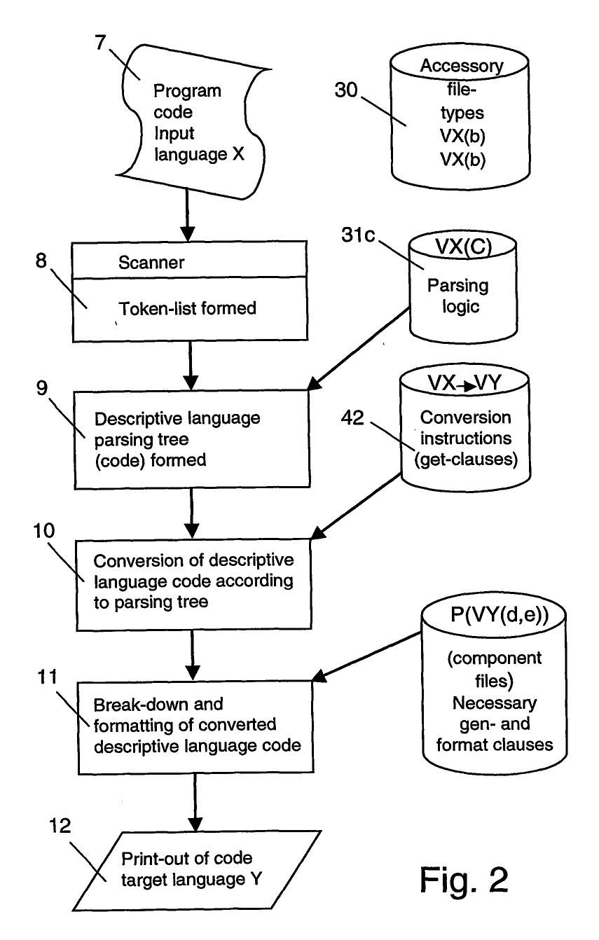

FIG. 2 shows a flow diagram of the operation of the translator.

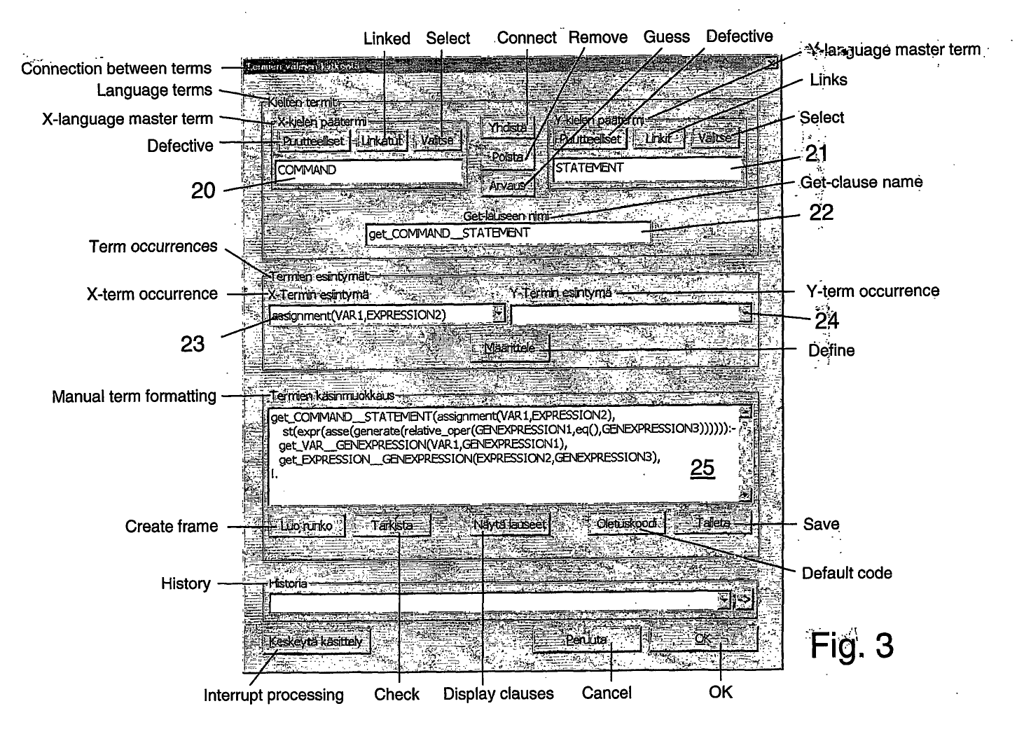

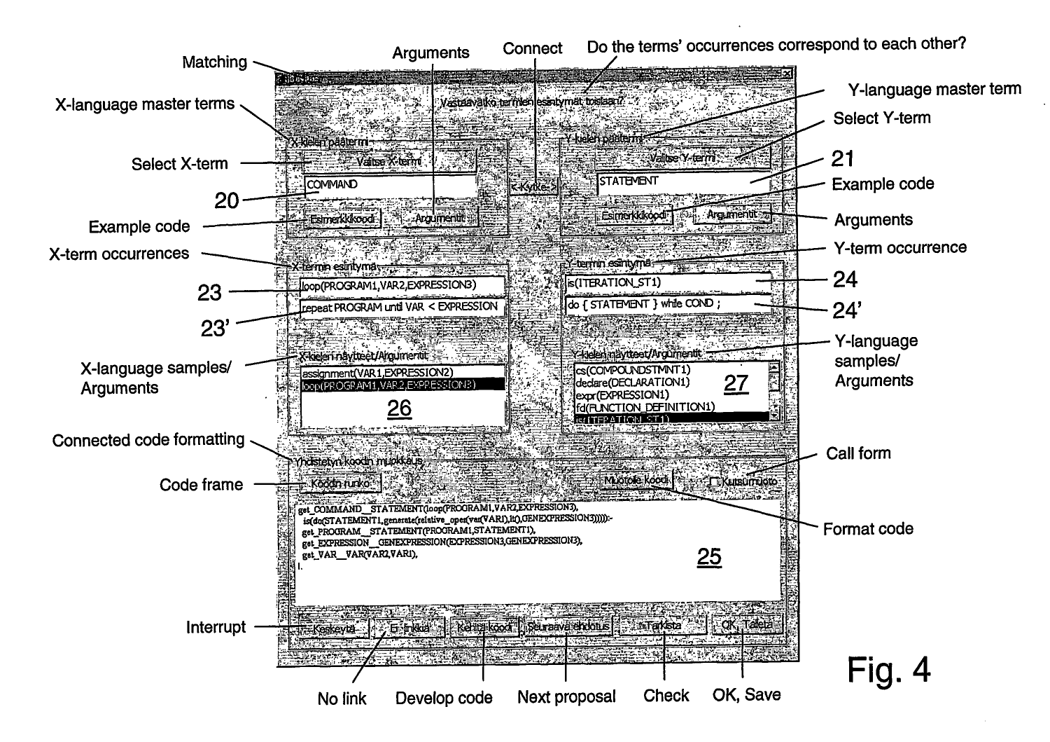

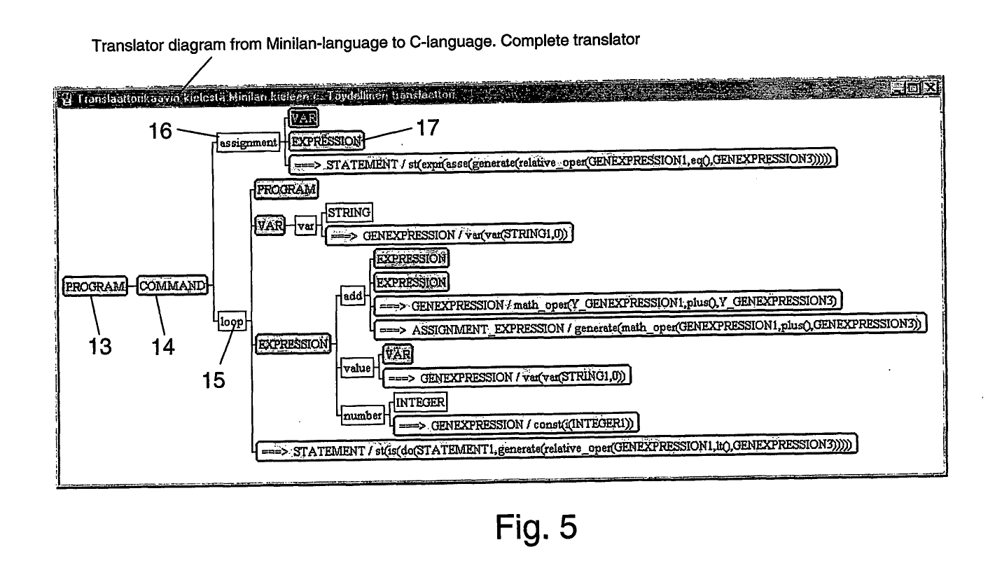

FIGS. 3 and 4 show a graphical interface for interaction connection FIG. 5 shows the semantic tree structure of the Minilan language with links to the C language.

The method according to the invention is suitable for developing a translator between two arbitrary source languages. In FIG. 1, the first source language is an input language X and the second source language is a target language Y. In the first stage, their grammars must be stored in a formal database, stages 1 and 1′, which are ‘handcraft’ stages that are independent of each other, but in which the same predefined naming practice (N) is used to permit later automatic processing, which is marked with the reference number 100. The implementation of the method requires a computer system together with software, which is later called the translator developer. In the accompanying examples, one preferred format is shown, according to which reserved words are written in small letters and the terms to be divided into parts (defined=non-terminals) are written in capitals and specific terms are replaced with selected signs and words, for example, “+” is “plus”, “=” is “eq”, “<” is “t”, a dot is “dot” In the example shown here, the input language used is the concise Minilan language and the source language is the C language.

In the following stage, a descriptive language version is formed, in this case typified for the PROLOG language, though some other typified, associative, and semantic representation may be envisaged, stages 2 and 2′. This takes place automatically, according to preselected rules. The Prolog language is described in the following publications: “Programming in Prolog”, 1984; W. F. Clocks C. S. Mellish (ISBN 3-540-15011-0 ISBN 0-387-15011-0), “Visual Prolog Perusteet” (‘Foundations of Visual Prolog’, in Finnish), 1995; Erkki Laitila, (ISBN-952-9823-51-7), “The Art of Prolog-advanced Programming Techniques”; Leon Sterling, MIT Press 1987 ISBN 0-262-19250-0. It is preferable to use Visual Prolog Developer (Prolog Development Center, DK), in which the necessary inference engine is integrated. The manufacturer of the developer has published the title: “PDC Prolog 3.20 Toolbox”, DK 1990.

Though the terms of both languages are converted into the descriptive language according to the same rules, as groups they still do not correspond to each other at all. Though some of the terms even have the same names in the descriptive language, they do not necessary correspond to each other, while there are several differences in the use of parameters. In the descriptive language version of the richer language, there are many terms that do not appear in the version in the other language. The making of the descriptive language conversion of both requires a simple PROLOG program or similar, the operation of which is shown clearly in the examples described later. In the examples according to the descriptive language, the words written in capital letters are divisible terms.

Expression in the descriptive language takes place very formally at a semantic level. It has a concise syntax relating to the manner of writing the grammar, each structure being given a clear syntactic name. The relation of the syntax to the form of the descriptive language is stored in accessory files, which is described later in greater detail. Each descriptive language conversion includes simplified information on the grammar of the source language. Here, the term file refers generally either to separate files in a mass-memory device, or to a group of records stored in a database. In practical applications, all the essential information is stored in a single database, because in most development environments data processing is then easiest

At this stage, accessory files 31 and 32 of the descriptive language conversions and the formally stored grammars can be formed entirely automatically for the translator (stages 3 and 3′). The conversion algorithms are given later. The glossary and scanner terms, datatypes, parsing logic, generating code, and format clauses are shown as the accessory files VX(a-e), 31 and correspondingly VY(a-e), 31′ of FIG. 1.

When the divisible terms are broken down into components at the lowest level, the reserved words remain to form the glossary for the scanner. The datatypes comprise the original terms and their hierarchic levels bound to the descriptive language occurrences.

The parsing logic gives formulae for converting each occurrence from the original code into the descriptive language form. Here there are generally several hierarchic levels, so that the master terms and the subsidiary terms are each set down in their own code. It is essential that the divisible terms form internal loops, which must be broken down until no more divisible terms can be found. Here it is possible to use some known high-grade parser logic, for example, the LL(k)-parser, which is a top-down type algorithm.

The generating codes show an essentially opposite process to the parsing logic and the format clauses are essentially opposite to the scanner operation. If the same source-language scanner, parser, generating, and formatting clauses are applied to the selected target code, the result should be the original code. This can be used to check the translator software.

With reference to FIG. 1, after running the accessory files, the interactive connection of the input and target language descriptive language terms is carried out, stage 4. This is “handcraft”, but it preferably takes place using a graphical interface 5 and an inference engine exploiting one or several of the following simple criteria:
the mutual combination of previously connected occurrences is proposed,
the mutual combination of occurrences/parameters with the same names based on the descriptive language terms is proposed,
the mutual combination of parameters on the basis of sequence is proposed.

The graphical interface includes features supporting translator development: a structure editor, which recognizes the structures of the input and target languages and permits a conversion instruction to be directed to an ever more precise level, by clicking on the corresponding term
an interpreter (a sub-group of the inference engine), which checks the logicality of the conversion instruction:
   each parameter should have at least two uses, exploitation of location and value
   each conversion instruction used that have been referred to must have a definition code
   if the conversion instruction parameters are given names corresponding to their types, it will be possible to carry out type-checks for each conversion instruction operation, even before the development of the translator
   the interpreter can be used to test the conversion instructions as independent totalities prior to the development of the translator.

Thus, the connection of the term VXᵢ of the input language to the term VYₙ converted into the selected target language is carried out in the steps:
the master terms are connected to each other
the occurrences are adapted to each other.

After this, the conversion instruction (VX [symbol] VY) of each converted input-language term (VXᵢ) is stored in file 41 for the translator.

In connection with the completion of the conversion instruction, the part of the target-language generating code is retrieved linked to the conversion instruction of each master term, which is necessary for the breaking down of each converted master term into parts, and is stored in the file 42.

Now the complete information is ready for the translation of code in an arbitrary input language X (the source code of a computer program) into a target language Y. A corresponding translator program is made in stage 6, when the translator's application code is translated and the previously created files and the accessory files required by the operating system are linked to it. It is preferable to use the PROLOG language, which has a concise and declarative syntax and is thus pre-eminently suitable as the final translator code and intermediate language and as test material.

The conversion instruction and accessory files can be located to be in a running file for the desired platform, such as, for example, MS-DOS, MS-Windows, or Linux. Operationally, the question is, however, of different groups of data, no matter whether they are separate files, in a common database, or inside the program to be run.

The translation is carried out (FIG. 2) by a system, generally a PC apparatus, in which there is
a translator (X>Y), generally a program connected to an input file 7, which translator reads the input file with the aid of a scanner 8 and generates a converted version of the computer program, and in which the translator includes conversion instructions VX [symbol] VY, 41 relating to each input-language term,
a translated file 12 connected to the translator (X>Y) for receiving the translated version of the computer program thus translated,
an operations library, in which are the routines to be called from the translator (X>Y).

The system also includes:
a first accessory file VX(c), 31c containing the parsing logic of the input language for the selected semantic descriptive language (V),
a second accessory file P(Y(d,e), containing the generating and format clauses of the input language,
   in which case the translator (X>Y) is arranged:
to convert the lines of code of the computer program, first of all into the form of the descriptive language, stage 9, using the parsing logic of the first accessory file VX(c);
then to convert them, stage 11, in the descriptive language form using a so-called conversion instruction VX [symbol] VY, 41
and to generate and format, stage 11, the descriptive language target-language code in the formal code 12 of the target language, using the target language's generating code VX(d), 42 and format clauses Y(d), 42.

In addition, the data types VX(b) and VY(b) of both languages should be available in the various stages. These too are stored for the translator, unless they are already contained in the other data.

FIGS. 3 and 4 show the interactive connection of the graphical interface. In FIG. 3, the first page of the interface has selection windows 20 and 21 for the proposed terms, selection windows 23 and 24 for their occurrences, a selection window 22 for the name of the get-clause, a selection window 25 for the conversion instruction being formed. In most of the selection windows, the terms can be clicked from a selection list to a pop-up window (not shown). In each such selection window, each component acts as a link to a corresponding selection list that appears.

In FIG. 4, the same reference numbers as above are used for operationally similar selection windows. In addition, in this case there are selection windows 23′ and 24′ for the source-language forms of the occurrences and selection windows 26 and 27 for the occurrences of the term.

Connection of Terms, Procedure, FIG. 3

The X-term and Y-term are selected, in this case PROGRAM and STATEMENT
The Connect button is clicked, if the connection takes place on the level of the master terms (either completely identical terms, or the connection has already been made at a lower level).
The Guess button is clicked, if the master terms are close to each other the developer will then ‘guess’ all the alternative connections.
Individual connection is carried out one occurrence at a time, in this case COMMANDLIST and cs(COMPOUNDSTMNT1). It is carried out through the Define button, using the dialogue “Term matching” (FIG. 4).
The code created can be edited afterwards in the manual-editing window.
   Matching of Terms, Procedure, FIG. 4:
The master terms are selected under EXPRESSION and GENEXPRESSION
Initially, the occurrence of “add” corresponding to addition is selected from the input language. The developer may propose “math_oper” as the corresponding occurrence in the target language, as the term “+” appears in the syntax of both.
The “code framework” button is clicked, in which case the conversion instruction header field appears together with its parameters in the display. The first parameter is the data structure of the input language and the second parameter is the data structure of the target language. The intention is to get them to correspond to each other, i.e. to create a semantic connection between them. Compatibility is obtained by clicking the Y-language parameters so many times that the situation is reached in which the number of the parameters of the X and Y-languages are the same. If necessary, standard data is used in the new language, or the surplus parameters of the input language are marked as unnecessary (by underlining). In this case, the mathematical addition operator of the target language must be selected manually. The selection takes place by clicking the word MATH_OPER once, when the developer will present its sub-alternatives, which in this case are plus, minus, star, and div.
It will now be noticed that there are the same number of variables in the input and target parameters. In the input parameters there are the variables EXPRESSION1 and EXPRESSION2, and in the target parameters the variables GENEXPRESSION1 and GENEXPRESSION2. It will further be noticed that the terms EXPRESSION and GENEXPRESSION are now being connected together that this connection can be exploited recursively to match the internal input and target parameters of the term.
Finally, the button “develop code” is clicked, when the developer will create the necessary conversion instruction by generating the lower-level conversion calls for the conversion between the input and target terms. The generation is now complete. The final result obtained is a PROLOG-language predicate (clause), which includes a header section and a condition section, separated by “if”, i.e. the symbol “.−”. The name of the header section is formed from the name of the input-language term, two underlinings and the name of the target-language term. The parameters are the input and target-language terms with their sub-parameters. The condition section includes predicate calls to other predicates, formed to break down the sub-parameters. The operation of this predicate is described in greater detail in connection with the translation of the example code.

If the translation is made from a higher-level language to a lower-level language, some terms or only some occurrence many remain unconverted. The source code contained in such components cannot then be translated entirely automatically, instead, such components must be replaced manually in the target language.

FIG. 5 shows the structure of language X, in this case Minilan.

The concept at the farthest left-hand side is PROGRAM, which is the language's starting symbol, 13. It is divided into sub-components through a list-definition. The list is composed of concepts 14 called COMMANDs, which in this case have a semantic name in the form assignment, 16, i.e. location, and loop, 15, i.e. program loop. The concept PROGRAM, 17 may reappear inside the program loop, and refers to a short piece of program. In most source languages, these would be separated from each other, i.e. the starting symbol might be called PROGRAM and the program blocks BLOCK. In the hierarchy tree of the Minilan language, there are at most six levels. For example, the corresponding tree for the Pascal language branches into a maximum of 20 levels while the C-language structure tree forms about 30 levels, due to the nested structure of the language. In the publication Turbo C Reference Guide, 1987, ISBN-0-87524-160-3, the syntax of the grammar of C is presented term by term. A structural presentation of the Microsoft Visual Basic 6.0 language in the form of FIG. 5 contains about 700 lines.

As one progresses typically downwards (i.e. to the right) in the diagram, every second term is written in capital letters and every other term begins in small letters. The capital letters represent the production of a grammatical concept (dark background) i.e. a master term and the terms beginning with small letters represent occurrences, which begin with a semantic name. Cells beginning with “--->” are links to a new language, in this case C (light-grey background). At the beginning of the link, the name of the new language production is stated while after the via-sign comes the semantic concept, which corresponds in the new language to the term in the X language. The semantic concept (light-grey background) is formed automatically in the translator developer, with the aid of interface operations.

As will be clear to one versed in the art, the method has numerous applications in the various fields of programming technique. The following presents applications, in all of which at least one input language grammar is used and at least one target language grammar, as well as crossings between them according to the method:

1. A translator from one language to another is developed, for example, Pascal-language source code is translated into C-language code. The languages are crossed according to the method.

2. Protocol software is developed in embedded systems. A domain specific language (DSL) is developed, which is based, for example, on C, but which contains additional calls to the object areas library routines and central data types. The protocol grammar is then crossed with this new domain specific language. The protocol language can be, for example, the language called CSN.1. which is used in GPRS and UMTS systems. Using the method, automatically ready-constructed codecs and decodecs of the protocol applications for the relevant data-transfer interfaces are obtained.

3. Configuration applications for industrial products or software applications are created in such a way that the input language is a domain specific language (DSL) and the target language is a selected programming language. The terms of the domain specific language include product characteristics data directories, or file systems, which are defined as grammar. The customer requirements are entered with the aid of an interface, as a result of which input-language text is created. It is converted with the aid of a crossing mechanism to form, for example, C-language product-configuration software.

4. The programs are translated to a limited-vocabulary language. The input language is the programming language and the target language is the desired sub-group of a natural language with its clause order.

5. The program code is transferred to CASE-means software development use. The software can be defined in a high-level language (domain specific language) at the start of a project. As the definition becomes more precise, a transfer is made to a traditional CASE-means taking into account the interface and data presentation formats of the CASE means, for example, the known UML presentation format.

6. The data structure and object structure data are selected from the program code and are converted to CASE-means graphical symbols and internal data structures. The part of the CASE-means forms the target language and the programming language the input language.

7. Test data is developed automatically for the application software using a separate test language, which is crossed with the application language. The test language can act, for example, as a customer simulator, which gives commands and target data according to an Internet interface.

The development of a translator between the COBOL and JAVA languages can be given as an example of the size of the files and the amount of work required. Manual formal descriptions of the grammars are 500-1000 lines. The automatically made accessory files are 8-10-times this size. The conversion instruction file is created when using a developer, particularly an interactive interface, within a few days.

Example Program

In the example program, there are commands according to the grammar, an assignment clause, and a repeating loop, which contains an incrementation command: addition and assignment of the result to a variable:

| | |
|---|---|
| I = 0. | ; assignment to variable |
| repeat I = I+1. | ; loop, in which there is an assignment, within |
| | which there is a further addition operation |
| until I<11. | |

The program's parsing tree after the scanner and parser is as follows:

[assignment(var(“i”),number(0)),loop([assignment(var(“i”),
add(value(var(“i”)),number(1)))],var(“i”),number(11))]

Start of Translation

The translation starts directly from the parsing tree without an intermediate stage (processing of the symbol table and reservation of the variables may precede the translation).

The generation of the input language parsing tree is started by exploiting directly the conversion instruction made between the terms. The generating code obtained from the translator generator is as follows:

gen_PROGRAM(X, Str):-
get_PROGRAM_{——}STATEMENT(X,Y),
gen_Y_STATEMENT(Y, Str), !.

2. At the starting stage, the variable X has the value:

X = [assignment(var(“i”),number(0)),loop([assignment(var(“i”),
add(value(var(“i”)),number(1)))],var(“i”),number(11))]

The variable Str returns the translation result as a character string. The variable Y contains the target-language equivalent of the variable X after the conversion get_PROGRAM_STATEMENT.

3. At the starting stage, the call stack of the translator is as follows (the call performed first is the lowest):

| | |
|---|---|
| 1 | gen_program( [assignment(var(“i”),number(0)), |
| | loop([assignment(var(“i”),add(value(var(“i”)),number(1)))], |
| | var(“i”),number(11))], _{—} ) |
| 2 | activate_translator() |

The parsing tree is interpreted as a STATEMENTLIST structure of the target language (C). The call stack has the following appearance:

| | |
|---|---|
| 1 | get_program_{——}statementlist( [assignment (var“i”),number(0)), |
| | loop([assignment (var(“i”),add(value(var(“i”)),number(1)))], |
| | var(“i”),number(11))], _{—} ) |
| 2 | get_program_{——}statement([assignment(var(“i”),number(0)), |
| | loop([assignment(var(“i”), |
| | add(value(var(“i”)),number(1)))],var(“i”),number(11))], _{—} ) |
| 3 | gen_program( [assignment(var(“i”),number(0)), |
| | loop([assignment(var(“i”),add(value(var(“i”)),number(1)))],var(“i”), |
| | number(11))], _{—} ) |
| 4 | activate_translator() |

The list STATEMENTLIST is divided into blocks, which are begun to be translated, starting from the beginning of the list. If there are blocks in the list, according to the Prolog definition the procedure moves to the second line, in which the first value of the list is obtained for the variable H1:

```
get_PROGRAM_{——}STATEMENTLIST([], []):- !.
    get_PROGRAM_{——}STATEMENTLIST([H1|T1], [H2|T2]):-
        get_COMMAND_{——}STATEMENT(H1, H2),
        get_PROGRAM_{——}STATEMENTLIST(T1, T2), !.
```

At this stage, the value for the variable H1 becomes:
H1=assignment(var(“i”),number(0))

and the variable T1 is assigned the value

T1 = [loop([assignment(var(“i”),add(value(var(“i”)),number(1)))],
var(“i”),number(11))]

The variables H2 and receive a value only at the terminating stage of the translation (H2 is thus _ and T2 is also _).

In the following stage, the first command, the assignment clause, in converted into the semantic of the target language, in which case the call stack is as follows:

| | |
|---|---|
| 1 | get_command_{——}statement( assignment(var(“i”),number(0)), _{—} ) |
| 2 | get_program_{——}statementlist( [assignment(var(“i”),number(0)), |
| | loop([assignment(var(“i”),add(value(var(“i”)),number(1)))], |
| | var(“i”),number(11))], _{—} ) |
| 3 | get_program_{——}statement([assignment(var(“i”),number(0)),loop([assignment |
| | (var(“i”),add(value(var(“i”)),number(1)))],var(“i”),number(11))], _{—} ) |
| 4 | gen_program( [assignment(var(“i”),number(0)),loop([assignment(var(“i”), |
| | add(value(var(“i”)),number(1)))],var(“i”),number(11))], _{—} ) |
| 5 | activate_translator() |

The repeat-until loop is translated by first dealing with the commands of the loop and finally the control structures. The call stack inside the loop is as follows:

| | |
|---|---|
| 1 | get_program_{——}statementlist( [loop([assignment(var(“i”),add(value |
| | (var(“i”)),number(1)))], var(“i”),number(11))], _{—} ) |
| 2 | get_program_{——}statementlist( [assignment(var(“i”),number(0)), loop([assignment |
| | (var(“i”),add(value(var(“i”)),number(1)))],var(“i”),number(11))], _{—} ) |
| 3 | get_program_{——}statement( [assignment(var(“i”),number(0)),loop([assignment |
| | (var(“i”), add(value(var(“i”)),number(1)))],var(“i”),number(11))], _{—} ) |
| 4 | gen_program( [assignment(var(“i”),number(0)),loop([assignment(var(“i”), |
| | add(value(var(“i”)),number(1)))],var(“i”),number(11))], _{—} ) |
| 5 | activate_translator() |

The conversion code corresponding to the program loop is as follows:

get_PROGRAM_{——}STATEMENTLIST([H1|T1], [H2|T2]):-
get_COMMAND_{——}STATEMENT(H1, H2),
get_PROGRAM_{——}STATEMENTLIST(T1, T2), !.

The program operates in such a way that the left parameter acts as the input parameter in the list format, the start of which list being the term H1 and the end of the list the term T1. After the conversion, the list of the farthest right-hand parameter is formed, the first value of which is H2 and the end of the list T2. Because the input list is a Command type and the target list is a Statement type, the conversion of the first pair of variables (H1->H2),requires the call get_COMMAND_STATEMENT, which returns the value H2. After the performance of this conversion, the principal operation calls the parameter values T1 and T2, which are further broken down recursively into the initial and final terms of the list, as defined in the Prolog language.

Coming to the code before the instancing of the variables, the variables have no value
(H1=_, T1=_, H2=_ja T2=_.

The first values of the variable pair (H1 ja T1) after the assignment clause:

H1 = assignment(var(“i”),number(0))
T1 = [loop([assignment(Var(“i”),add(Value(Var(“i”)),number(1)))],
var(“i”),number(11))]

The variables H2 and T2 have initially no value (their states are H2=_, T2=_ according to Prolog's definition).

After the performance of the assignment clause, the variable H1 has the value:

H1 = loop([assignment(var(“i”),add(value(var(“i”)),number(1)))],
var(“i”),number(11))

The program terminates with a loop command, so that T1 receives the value [ ] (empty group).

Next, the translation of the loop is carried out using the conversion instruction
get_COMMAND_STATEMENT:

(Example of FIG. 4)

```
get_COMMAND_STATEMENT(loop(PROGRAM1,VAR2,
EXPRESSION3),
    is(do(STATEMENT1,generate(relative_oper(var(VAR1),lt( ),
    GENEXPRESSION3))))):-
  → get_PROGRAM_STATEMENT(PROGRAM1,STATEMENT1),
  get_EXPRESSION_GENEXPRESSION(EXPRESSION3,
  GENEXPRESSION3),
  get_VAR_VAR(VAR2,VAR1),
!.
```

Here the translator meets the “loop” command, in FIG. 4 a call follows to the formed clause, which contains a target-language (descriptive language) term and the sub-terms of both sides. From this call, the translation program forms calls to the clauses defined by the divisible sub-terms and recursively always new calls, until indivisible clauses can be returned for the variables.

In this case, the values of the variables in the loop are as follows:

PROGRAM1 = [assignment(var(“i”),add(value(var(“i”)),number(1)))]
VAR2 = var(“i”)
EXPRESSION3 = number(11)

In the above command, the variables STATEMENT1, VAR1 ja GENEXPRESSION3 have no value in the place shown by the arrow.

The assignment clause inside the loop is as follows:

```
get_command_statement(assignment(var(“i”),add(value(var(“i”)),
  number(1))), _{—} )
get_COMMAND_STATEMENT(assignment(VAR1,EXPRESSION2),
  expr(asse(generate(relative_oper(GENEXPRESSION1,eq( ),
  GENEXPRESSION3))))):-
  → get_VAR_GENEXPRESSION(VAR1,GENEXPRESSION1),
  → get_EXPRESSION_GENEXPRESSION(EXPRESSION2,
  GENEXPRESSION3),
  !.
```

The variables in the place shown by the arrow are:

VAR1 = var(“i”)
EXPRESSION2 = add(value(var(“i”)),number(1))

The variables in the place shown by the thick arrow are:

VAR1 = var(“i”)
EXPRESSION2 = add(value(var(“i”)),number(1))
GENEXPRESSION1 = var(var(“i”,0))

The variables after the line shown by the thick arrow are:

VAR1 = var(“i”)
EXPRESSION2 = add(value(var(“i”)) ,number(1))
GENEXPRESSION1 = var(var(“i”,0))
GENEXPRESSION3 = math_oper(var(var(“i”,0)),plus,const(i(1)))

The call stack in the assignment clause inside the loop is as follows:

```
1 get_program_statement([assignment(var(“i”),add(value(var(“i”)),
      number(1)))], _{—} )
2 get_command_statement( loop([assignment(var(“i”),
      add(value(var(“i”)),number(1)))],var(“i”),number(11)), _{—} )
3 get_program_statementlist([loop([assignment(var(“i”),
      add(value(var(“i”)),number(1)))] ,var(“i”),number(11))], _{—} )
4 get_program_statementlist( [assignment(var(“i”),
      number(0)),loop([assignment(var(“i”),add(value(var(“i”)),
      number(1)))] ,var(“i”),number(11))], _{—} )
5 get_program_statement([assignment(var(“i”),number(0)),
          loop([assignment(var(“i”), add(value(var(“i”)),number(1)))],
          var(“i”),number(11))], _{—} )
6 gen_program( [assignment(var(“i”),number(0)),
      loop([assignment(var(“i”),add(value(var(“i”)),
      number(1)))] ,var(“i”),number(11))], _{—} )
7 activate_translator()
```

At the start of the loop, the variable PROGRAM receives the value:
PROGRAM=[assignment(var(“i”),add(value(var(“i”)),number(1)))]

The call stack at the end of the assignment clause is:

```
1 get_program_statementlist( [assignment(var(“i”),
    add(value(var(“i”)), number(1)))], _{—} )
2 get_program_statement( [assignment(var(“i”),
    add(value(var(“i”)), number(1)))], _{—} )
3 get_command_statement( loop([assignment(var(“i”),
      add(value(var(“i”)), number(1)))],var(“i”),number(11)), _{—} )
4 .....
```

The variables at the end of the clause are:

| | |
|---|---|
| H1 | = assignment(var“i”),add(value(var(“i”)),number(1))) |
| T1 | = [ ] |
| H2 | = expr(asse(generate(relative_oper(var(var(“i”,0)), |
| | eq,math_oper(var(var(“i”,0)),plus,const(i(1))))))) |
| T2 | = _{—} |

Variable H2 thus contains the target-language equivalent to variable H1.

The call stack in the assignment clause inside the loop is:

| | |
|---|---|
| 1 | get_program_statement( [assignment(var(“i”), |

add(value(var(“i”)), number(1)))], _{—} )

| | |
|---|---|
| 2 | get_command_statement(loop([assignment(var(“i”), |
| | add(value(var(“i”)), number(1)))], var(“i”),number(11)), _{—} ) |
| 3 | get_program_statementlist([loop([assignment(var(“i”), |
| | add(value(var(“i”)), number(1)))], var(“i”),number(11))], _{—} ) |
| 4 | ......... |

The value of the loop's internal code is in the variable PROGRAM:
PROGRAM=[assignment(var(“i”),add(value(var(“i”)),number(1)))]

The corresponding target-language value in the variable STATEMENTLIST1=[expr(asse(generate(relative_oper(var(var(“i”,0)),eq,math_oper(var(var(“i”,0)),plus,const(i(1)))))))]

The call stack in the situation, when returning from the loop:

| | |
|---|---|
| 1 | get_command_statement( loop([assignment(var(“i”), |
| | add(value(var(“i”)), number(1)))], var(“i”),number(11)), _{—} ) |
| 2 | get_program_statementlist([loop([assignment(var(“i”), |

add(value(var(“i”)), number(1)))],var(“i”),number(11))], _{—} )

| | |
|---|---|
| 3 | get_program_statementlist( [assignment(var(“i”),number(0)), |

loop([assignment(var(“i”),add(value(var(“i”)),number(1)))],
var(“i”),number(11))], _{—} )

4...........

The variables after the return from the loop are:

```
PROGRAM1 = [assignment(var(“i”),add(value(var(“i”)),number(1)))]
VAR2 = var(“i”)
EXPRESSION3 = number(11)
STATEMENT1 =
  cs(stmntlist([expr(asse(generate(relative_oper(var(var(“i”,0)),
  eq,math_oper(var(var(“i”,0)),plus,const(i(1)))))))]))
VAR1 = _{—}
GENEXPRESSION3 = _{—}
```

In the loop command conversion stage the call stack is as follows:

| | |
|---|---|
| 1 | get_command_statement( loop([assignment(var(“i”), |
| | add(value(var(“i”)), number(1)))], var(“i”),number(11)), _{—} ) |
| 2 | get_program_statementlist([loop([assignment(var(“i”), |
| | add(value(var(“i”)), number(1)))], var(“i”),number(11))], _{—} ) |
| 3 | get_program _statementlist( [assignment(var(“i”),number(0)), |

loop([assignment(var(“i”),add(value(var(“i”)),number(1)))],
var(“i”),number(11))], _{—} )

| | |
|---|---|
| 4 | ................ |

In this stage, the values of the variables are:

PROGRAM1 = [assignment(var(“i”),add(value(var(“i”)),number(1)))]
VAR2 = var(“i”)
EXPRESSION3 = number(11)STATEMENT1 =
cs(stmntlist([expr(asse(generate(relative_oper(var(var(“i”,0)),
eq,math_oper(var(var (“i”,0)),plus,const(i(1)))))))]))
VAR1 = _{—}
GENEXPRESSION3 = const(i(11))

The call stack in the loop is:

| | |
|---|---|
| 1 | get_command_statement( loop([assignment(var(“i”), |
| | add(value(var(“i”)), number(1)))], var(“i”),number(11)), _{—} ) |
| 2 | get_program_statementlist([loop([assignment(var(“i”), |
| | add(value(var(“i”)), number(1)))], var(“i”),number(11))], _{—} ) |
| 3 | get_program_statementlist([assignment(var(“i”),number(0)), |
| | loop([assignment (var(“i”), add(value(var(“i”)),number(1)))], |
| | var(“i”),number(11))], _{—} ) |
| 4 | ................. |

After the call, the variables are:

```
PROGRAM1 = [assignment(var(“i”),add(value(var(“i”)),number(1)))]
VAR2 = var(“i”)
EXPRESSION3 = number(11)
STATEMENT1 = cs(stmntlist([expr(asse(generate(
    relative_oper(var(var(“i”,0)),eq,math_oper(var(var(“i”,0)),
    plus,const(i(1)))))))]))
VAR1 = var(“i”,0)
GENEXPRESSION3 = const(i(11))
```

After the solution of the code loop, the variable situation is:

```
H1 = loop([assignment(var(“i”),add(value(var(“i”)),number(1)))],
    var(“i”),number(11))
T1 = [ ]
H2 = is(do(cs(stmntlist([expr(asse(generate(
    relative_oper(var(var(“i”,0)),eq,math_oper(var(var(“i”,0)),plus,
    const(i(1)))))))])),generate(relative_oper(var(var(“i”,0)),lt,
    const(i(11))))))
T2 = _{—}
```

When solving the addition clause, the call stack is:

```
1  get_expression_{——}genexpression( add(value(var(“i”)),number(1)), _{—} )
2  get_command_{——}statement( assignment(var(“i”),add(value(var(“i”)),
    number(1))), _{—} )
3  get_program_{——}statementlist( [assignment(var(“i”),add(value(var(“i”)),
    number(1)))], _{—} )
4  get_program_{——}statement( [assignment(var(“i”),add(value(var(“i”)),
    number(1)))], _{—} )
5  get_command_{——}statement( loop([assignment(var(“i”),add(value(var(“i”)),
      number(1)))], var(“i”),number(11)), _{—} )
6  get_program_{——}statementlist([loop([assignment(var(“i”), add(value(var(“i”)),
      number(1)))], var(“i”),number(11))], _{—} )
7  get_program_{——}statementlist( [assignment(var(“i”),number(0)), loop([assignment
      (var(“i”),add(value(var(“i”)),number(1)))],var(“i”), number(11)))], _{—} )
8  get_program_{——}statement( [assignment(var(“i”),number(0)),loop([assignment
      (var(“i”), add(value(var(“i”)),number(1)))],var(“i”),number(11))], _{—} )
9  gen_program( [assignment(var(“i”),number(0)),loop([assignment(var(“i”),
      add(value(var(“i”)),number(1)))],var(“i”),number(11))], _{—} )
10  activate_translator( )
```

In the loop's internal assignment clause, the call stack is as follows:

```
1  get_command_{——}statement( assignment(var(“i”),
    add(value(var(“i”)),number(1))), _{—} )
2  get_program_{——}statementlist( [assignment(var(“i”),
    add(value(var(“i”)),number(1)))], _{—} )
3  get_program_{——}statement( [assignment(var(“i”),
    add(value(var(“i”)),number(1)))], _{—} )
4  ........
```

After carrying out the addition, the variables are:

VAR1 = var(“i”)
EXPRESSION2 = add(value(var(“i”)),number(1))
GENEXPRESSION1 = var(var(“i”, 0))
GENEXPRESSION3 = math_oper(var(var(“i”,0)),plus,const(i(1)))

When the loop terminates, the call stack is as follows:

```
1  get_program_{——}statementlist( [ ], _{—} )
2  get_program_{——}statementlist(
      [loop([assignment(var(“i”),add(value(var(“i”)-), number(1)))],
      var(“i”), number(11))], _{—} )
3  get_program_{——}statementlist(
      [assignment(var(“i”),number(0)),loop([assignment(var(“i”),
      add(value(var(“i”)),number(1)))],var(“i”),number(11))], _{—} )
4  ...............
```

When the program terminates, the call stack is as follows:

```
1  get_program_{——}statementlist([assignment(var(“i”),number(0)),loop([assignment
      (var(“i”), add(value(var(“i”)),number(1)))],var(“i”),number(11))], _{—} )
2  get_program_{——}statement([assignment(var(“i”),number(0)),loop([assignment
      (var(“i”), add(value(var(“i”)),number(1)))],var(“i”)number(11))], _{—} )
3  gen_program( [assignment(var(“i”),number(0)),loop([assignment(var(“i”),
    add(value(var(“i”)),number(1)))],var(“i”),number(11))], _{—} )
4  activate_translator( )
```

The variable situation at the termination of the program:

```
H1 = assignment(var(“i”),number(0))
T1 = [loop([assignment(var(“i”),add(value(var(“i”)),number(1)))],
var(“i”),number(11))]
H2 = expr(asse(generate(relative_oper(var(var(“i”,0)),eq,const(i(0))))))
T2 = [is(do(cs(stmntlist([expr(asse(generate(relative_oper(
  var(var(“i”,0)),eq,math_oper(var(var(“i”,0)),plus,const(i(1)))))))])),
  generate(relative_oper(var(var(“i”,0)),lt,const(i(11))))))]
1  get_program_{——}statement([assignment(var(“i”),number(0)),loop( [assignment
        (var(“i”), add(value(var(“i”)),number(1)))],var(“i”),number(11))], _{—} )
2  gen_program([assignment(var(“i”),number(0)),1oop([assignment(var(“i”),
        add(value (var(“i”)),number(1)))],var(“i”),number(11))], _{—} )
3  activate_translator( )
```

Finally, a target-language parsing tree corresponding to the original program PROGRAM is obtained in the variable STATEMENTLIST1:

```
PROGRAM = [assignment(var(“i”),number(0)),loop([assignment(var(“i”),
  add(value(var(“i”)),number(1)))],var(“i”),number(11))]
STATEMENTLIST1 =[expr(asse(generate(relative_oper(var(var(“i”,0)),
  eq,
  const(i(0)))))),
  is(do(cs(stmntlist([expr(asse(generate(relative_oper(var(var(“i”,0)),
  eq,math_oper(var(var(“i”,0)),plus,const(i(1)))))))])),
  generate(relative_oper(var(var(“i”,0)),lt,const(i(11))))))]
```

Finally, the procedure moves to the input-language program's code's clause gen_program, in which only now the solution is initiated of the target-language syntax variable Str. At this stage, the call stack is:

```
1  gen_program( [assignment(var(“i”),number(0)),
    loop([assignment(var(“i”),add(value(var(“i”)),
    number(1)))],var(“i”),number(11))], _{—} )
2  activate_translator( )
```

The variable situation prior to the definition of the target-language syntax is as follows:

```
X = [assignment(var(“i”),number(0)),loop([assignment(var(“i”),
add(value(var(“i”)),  number(1)))],var(“i”),number(11))]
Str = _{—}
Y = cs(stmntlist([expr(asse(generate(relative_oper(var(var(“i”,0)),
  eq,const(i(0)))))),is(do(cs(stmntlist([expr(asse(generate(relative_oper(
  var(var(“i”,0)),eq,math_oper(var(var(“i”,0)),plus,const(i(1)))))))])),
  generate(relative_oper(var(var(“i”,0)),lt,const(i(11))))))]))
```

Gen Clauses

In the following, code generation is started to define the syntax portion of the target language:

```
1  gen_y_statement( cs(stmntlist([expr(asse(generate
    (relative_oper(var(var(“i”,0)),eq,const(i(0)))))),
    is(do(cs(stmntlist([expr(asse(generate(relative_oper(var(var(“i”,0)),
    eq,math_oper(var(var(“i”,0)),plus,const(i(1)))))))])),
    generate(relative_oper(var(var(“i”,0)),lt,
    const(i(11))))))])), _{—} )
2  gen_program( [assignment(var(“i”),number(0)),loop
    ([assignment(var(“i”),add(value(var((“i”)),number(1)))],
    var(“i”),number(11))], _{—} )
3  activate_translator( )
```

The variable at the start when moving to the compound statement:

```
COMPOUNDSTMNT1 = stmntlist([expr(asse(generate(relative_oper(var(
  var(“i”,0)),eq,const(i(0)))))),is(do(cs(stmntlist([expr(asse(generate(
  relative_oper(var(var(“i”, 0)),eq,math_oper(var(var(“i”,0)),plus,
  const(i(1)))))))])),generate(relative_oper(var(var(“i”,0)),lt,
  const(i(11))))))])
Str = _{—}
Str1 = _SList = _{—}
```

In the following, the definition of the syntax of the C-language assignment clause i=0 is started:

| | |
|---|---|
| 1 | gen_y_statement( expr(asse(generate(relative_oper(var(var(“i”, |
| | 0)),eq,const(i(0)))))), _{—} ) |
| 2 | gen_y_statement( [expr(asse(generate(relative_oper(var(var(“i”, |
| | 0)),eq,const(i(0)))))),is(do(cs(stmntlist([expr(asse(generate( |
| | relative_oper(var(var(“i”,0)),eq,math_oper(var(var(“i”,0)),plus, |
| | const(i(1)))))))])),generate(relative_oper(var(var(“i”,0)),lt, |
| | const(i(11))))))], _{—} ) |
| 3 | gen_y_compoundstmnt( stmntlist([expr(asse(generate |
| | (relative_oper(var(var(“i”,0)),eq,const(i(0)))))),is(do(cs(stmntlist([ |
| | expr(asse(generate(relative_oper(var(var(“i”,0)),eq,math_oper(var( |
| | var(“i”,0)),plus,const,(i(1)))))))])),generate(relative_oper( |
| | var(var(“i”,0)),lt,const(i(11))))))]), _{—} ) |
| 4 | ............... |

In the assignment clause, the variable EXPRESSION1 receives the value:
EXPRESSION1=asse(generate(relative_oper(var(var(“i”,0)),eq,const(i(0)))))

Its conversion into source language takes place using the clause gen_output:

| | |
|---|---|
| 1 | gen_output( [“i”,“=”,“0”], “genexpression_relative_oper”, _{—} ) |
| 2 | gen_y_genexpression( relative_oper(var(var(“i”,0)),eq, |
| | const(i(0))), _{—} )gen_y_assignment_expression( generate |
| | (relative_oper(var(var(“i”,0)),eq,const(i(0)))), _{—} ) |
| 3 | gen_y_expression( asse(generate(relative_oper(var(var |
| | (“i”,0)),eq,const(i(0))))), _{—} ) |
| 4 | ........................ |

The following value is taken to the generating clause gen-output
Slist=[“i”, “=”, “0”]

At the same time, the format clause Form is called using the following value:
Form=“genexpression_relative_oper”

Using the value Form the corresponding format clause is retrieved from the accessory file C.FRM. The call stack of the assignment clause (i≈0) is as follows:

| | |
|---|---|
| 1 | gen_output( [“i = 0”], “assignment_expression_generate”, _{—} ) |
| 2 | gen_y_assignment_expression( generate(relative_oper(var |
| | (var(“i”,0)),eq,const(i(0)))), _{—} ) |
| 3 | gen_y_expression( asse(generate(relative_oper(var(var(“i”,0)),eq, |
| | const(i(0))))), _{—} ) |
| 4 | ................... |

The variable situation in the formation of the assignment clause is:
Slist=[“i=0”]
Form=“assignment_expression_generate”
Str=_{—}
StrF=_{—}

In the incrementation stage, the call stack is as follows:

| | |
|---|---|
| 1 | gen_output( [“i = i + 1”), “assignment_expression_generate”, _{—} ) |
| 2 | gen_y_assignment_expression(generate(relative_oper(var(var (“i”,0)), |
| | eq,math_oper(var(var(“i”,0)),plus,const(i(1))))), _{—} ) |
| 3 | gen_y_expression( asse(generate(relative_oper(var(var(“i”,0)),eq, |
| | math_oper(var(var(“i”,0)),plus,const(i(1)))))), _{—} ) |
| 4 | gen_y_statement( expr(asse(generate(relative_oper(var(var(“i”,0)),eq, |
| | math_oper(var(var(“i”,0)),plus,const(i(1))))))), _{—} ) |
| 5 | gen_y_statementlist( [expr(asse(generate(relative_oper(var(var(“i”,0)),eq, |
| | math_oper(var(var(“i”,0)),plus,const(i(1)))))))], _{—} ) |
| 6 | gen_y_compoundstmnt( stmntlist([expr(asse(generate(relative_oper(var( |
| | var(“i”,0)),eq,math_oper(var(var(“i”,0)),plus,const(i(1)))))))]), _{—} ) |
| 7 | gen_y_statement( cs(stmntlist([expr(asse(generate(relative_oper(var( |
| | var(“i”,0)),eq,math_oper(var(var(“i”,0)),plus,const(i(1)))))))])), _{—} ) |
| 8 | gen_y_iteration_st( do(cs(stmntlist([expr(asse(generate(relative_oper(var( |
| | var(“i”,0)),eq,math_oper(var(var(“i”,0)),plus,const( |
| | i(1)))))))])),generate(relative_oper(var(var(“i”,0)),lt, |
| | const(i(11))))), _{—} ) |
| 9 | gen_y_statement( is(do(cs(stmntlist([expr(asse(generate(relative_oper( |
| | var(var(“i”,0)),eq,math_oper(var(var(“i”,0)),plus,const(i(1)))))))])), |
| | generate(relative_oper(var(var(“i”,0)),lt,const(i(11)))))), _{—} ) |
| 10 | gen_y_statementlist( [is(do(cs(stmntlist([expr(asse(generate( |
| | relative_oper(var(var(“i”,0)),eq,math_oper(var(var(“i”,0)), |
| | plus,const(i(1)))))))])),generate(relative_oper(var(var(“i”,0)), |
| | lt,const(i(11))))))], _{—} ) |
| 11 | gen_y_statementlist( [expr(asse(generate(relative_oper(var(var(“i”,0)), |
| | eq,const(i(0)))))),is(do(cs(stmntlist([expr(asse(generate( |
| | relative_oper(var(var(“i”,0)),eq,math_oper(var(var(“i”,0)), |
| | plus,const(i(1)))))))])),generate(relative_oper(var(var(“i”,0)), |
| | lt,const(i(11))))))], _{—} ) |
| | gen_y_compoundstmnt( stmntlist([expr(asse(generate(relative_oper(var(var( |
| | “i”,0)),eq,const(i(0)))))),is(do(cs(stmntlist([expr(asse( |
| | generate(relative_oper(var(var(“i”,0)),eq,math_oper(var( |
| | var(“i”,0)),plus,const(i(1)))))))])),generate(relative_oper( |
| | var(var(“i”,0)),lt,const(i(11))))))]), _{—} ) |
| 12 | gen_y_statement( cs(stmntlist([expr(asse(generate( |
| | relative_oper(var(var(“i”,0)),eq,const(i(0)))))),is(do(cs(stmntlist( |
| | [expr(asse(generate(relative_oper(var(var(“i”,0)),eq, |
| | math_oper(var(var(“i”,0)),plus,const(i(1)))))))])), |
| | generate(relative_oper(var(var(“i”,0)),lt,const(i(11))))))])), _{—} ) |
| 13 | gen_program( [assignment(var(“i”),number(0)),loop([assignment(var(“i”), |
| | add(value(var(“i”)),number(1)))],var(“i”),number(11))], _{—} ) |
| 15 | activate_translator( ) |

In the incrementation stage, the formatting clause “assignment_expression_generate” is used:
Slist=[“i=i+1”]
Form=“assignment_expression_generate”

When forming the call stack, the final assignment clause is as follows:

| | |
|---|---|
| 1 | gen_y_expression( asse(generate(relative_oper(var(var(“i”,0)), |
| | eq,math_oper(var( var(“i”,0)),plus,const(i(1)))))), _{—} ) |
| 2 | gen_y_statement( expr(asse(generate(relative_oper (var(var(“i”,0)), |
| | eq,math_oper(var(var(“i”,0)),plus,const(i(1))))))), _{—} ) |
| 3 | gen_y_statementlist( [expr(asse(generate(relative_oper(var(var |
| | (“i”,0)),eq,math_oper(var(var(“i”,0)),plus,const(i(1)))))))], _{—} ) |
| 4 | gen_y_compoundstmnt( stmntlist([expr(asse(generate |
| | (relative_oper(var(var(“i”,0)),eq,math_oper(var(var(“i”,0)),plus, |
| | const(i(1)))))))]), _{—} ) |
| 5 | gen_y_statement( cs(stmntlist([expr(asse(generate(relative_oper |

(var(var(“i”,0)),eq,math_oper(var(var(“i”,0)),plus,
const(i(1)))))))])), _{—} )

| | |
|---|---|
| 6 | ............ |

After the formatting of the assignment clause, the variables are:

ASSIGNMENT_EXPRESSION1 = generate(relative_oper(var(var(“i”,
0)),eq,math_oper(var(var(“i”,0)),plus,const(i(1)))))
Str = “i = i + 1”
Str1 = “i = i + 1”
SList = [“i = i + 1”]

In the following, the formation of a block (corresponding to the content of the input-language loop) above the assignment clause is commenced:

| | |
|---|---|
| 1 | gen_output( [“{ i = i + 1 ; }”], “statement_cs”, _{—} ) |
| 2 | gen_y_statement( cs(stmntlist([expr(asse(generate(relative_oper( |
| | var(var(“i”,0)),eq,math_oper(var(var(“i”,0)),plus, |
| | const(i(1)))))))])), _{—} ) |
| 3 | gen_y_iteration_st( do(cs(stmntlist([expr(asse(generate |
| | (relative_oper(var(var(“i”,0)),eq,math_oper(var(var(“i”,0)),plus, |
| | const(i(1)))))))])),generate(relative_oper(var(var(“i”,0)), |
| | lt,const(i(11))))), _{—} ) |
| 4 | gen_y_statement( is(do(cs(stmntlist([expr(asse(generate |
| | (relative_oper(var(var(“i”,0)),eq,math_oper(var(var(“i”,0)),plus, |
| | const(i(1)))))))])),generate(relative_oper(var(var(“i”,0)), |
| | lt,const(i(11)))))), _{—} ) |
| 5 | ............... |

The values of the variables produced by the code contained in the loop are:

Slist = [“{ i = i + 1 ; }”]
Form = “statement_cs”

Next, the code of the control structure of the loop is formed:

| | |
|---|---|
| 1 | gen_output( [“{ i = i + 1 ; }”,“i < 11”], “iteration_st_do”, _{—} ) |
| 2 | gen_y_iteration_st( do(cs(stmntlist([expr(asse(generate |
| | (relative_oper(var(var(“i”,0)),eq,math_oper(var(var(“i”,0)),plus, |
| | const(i(1)))))))])),generate(relative_oper(var(var(“i”,0)),lt,const |
| | (i(11))))), _{—} ) |
| 3 | gen_y_statement( is(do(cs(stmntlist([expr(asse(generate |
| | (relative_oper(var(var(“i”,0)),eq,math_oper(var(var(“i”,0)),plus, |
| | const(i(1)))))))])),generate(relative_oper(var(var(“i”,0)),lt,const |
| | (i(11)))))), _{—} ) |
| 4 | gen_y_statementlist( [is(do(cs(stmntlist([expr(asse(generate( |

relative_oper(var(var(“i”,0)),eq,math_oper(var(var(“i”,0)),plus,

| | |
|---|---|
| | const(i(1)))))))])),generate(relative_oper(var(var(“i”,0)), |
| | lt,const(i(11))))))], _{—} ) |
| 5 | ............. |

At the beginning of the formatting of the loop, the variables are:

Slist = [“{ i = i + 1 ; }”,“i < 11”]
Form = “iteration_st_do”

At this stage, the call stack is:

```
1 gen_output( [“do { i = i + 1 ; } while ( i < 11 )”],
      “statement_is”, _{—} )
2 gen_y_statement( is(do(cs(stmntlist([expr(asse(generate(relative_oper(var(var(“i”,0)),
      eq,math_oper(var(var(“i”,0)),plus,
      const(i(1)))))))])),generate(relative_oper(var(var(“i”,0)),
      lt,const(i(11)))))), _{—} )
3 gen_y_statementlist([is(do(cs(stmntlist([expr(asse(generate(relative_oper(var(var(“i”,0)),
eq,math_oper(var(var(“i”,0)),plus,const(i(1)))))))])),
      generate(relative_oper(var(var(“i”,0)),lt,const(i(11))))))], _{—} )
4 gen_y_statementlist( [expr(asse(generate(relative_oper(var(var(“i”,0)),eq,
      const(i(0)))))),is(do(cs(stmntlist([expr(asse(generate(relative_oper(var(var(“i”,0)),
      eq,math_oper(var(var(“i”,0)),
      plus,const(i(1)))))))])),generate(relative_oper(var(var(“i”,0)),
      lt, cost(i(11))))))], _{—} )
5 gen_y_compoundstmnt( stmntlist([expr(asse(generate(relative_oper(var(var(“i”,0)),
eq,const(i(0)))))),is(do(cs(stmntlist([expr(asse(generate(relative_oper(var(var(“i”,0)),
      eq,math_oper(var(var(“i”,0)),
      plus,const(i(1)))))))])),generate(relative_oper(var(var(“i”,0)),
      lt,const(i(11))))))]), _{—} )
6 ..............
```

The formatting of the loop command begins from the variable situation:

Slist = [“do {i = i + 1;}while (i < 11)”]
Form = “statement_is”

The formatting of the entire program starts from the following call stack:

```
1 gen_output( [“i = 0 ; do { i = i + 1 ; } while ( i < 11 ) ;”],
      “compoundstmnt_stmntlist”, _{—} )
2 gen_y_compoundstmnt( stmntlist([expr(asse(generate(relative_oper(var( var(“i”,0)),
      eq,const(i(0)))))),is(do(cs(stmntlist([expr(asse(generate(relative_oper(var(var(“i”,0)),
      eq,math_oper(var(var(“i”,0)),
      plus,const(i(1)))))))])),generate(relative_oper(var(var(“i”,0)),
      lt,const(i(11))))))]), _{—} )
3 gen_y_statement( cs(stmntlist([expr(asse(generate(relative_oper(var(var(“i”,0)),
      eq,const(i(0)))))),is(do(cs(stmntlist([expr(asse(generate(relative_oper(var(var(“i”,0)),
      eq,math_oper(var(var(“i”,0)),
      plus,const(i(1)))))))])),generate(relative_oper(var(var(“i”,0)),
      lt,const(i(11))))))])), _{—} )
4 gen_program( [assignment(var(“i”),number(0)),loop([assignment(var(“i”),
      add(value(var(“i”)),number(1)))],var(“i”),number(11))], _{—} )
5 activate_translator( )
```

The variables are then:

Slist = [“i = 0 ; do { i = i + 1 ; } while ( i < 11 ) ;”]
Form = “compoundstmnt_stmntlist”

A group of C clauses (Compound Statement) as generated as source-language C-code using the clause:

```
gen_Y_COMPOUNDSTMNT(stmntlist(STATEMENTLIST1) ,Str):-
    gen_Y_STATEMENTLIST(STATEMENTLIST1,Str1),
    SList =[Str1],
    gen_output(SList, “compoundstmnt_stmntlist”, Str), !.
```

The call stack is then as follows:

```
1 gen_y_compoundstmnt( stmntlist([expr(asse(generate(relative_oper(var(var(“i”,0)),
      eq,const(i(0)))))),is(do(cs(stmntlist([expr(asse(generate(relative_oper(var(var(“i”,0)),
      eq,math_oper(var(var(“i”,0)),
      plus,const(i(1)))))))])),generate(relative_oper(var(var(“i”,0)),
      lt,const(i(11)))))]), _{—} )
2 gen_y_statement( cs(stmntlist([expr(asse(generate(relative_oper(var(var(“i”,0)),
      eq,const(i(0)))))),is(do(cs(stmntlist([expr(asse(generate(relative_oper(var(var(“i”,0)),
      eq,math_oper(var(var(“i”,0)),
      plus,const(i(1)))))))])),generate(relative_oper(var(var(“i”,0)),
      lt,const(i(11))))))])), _{—} )
3 gen_program( [assignment(var(“i”),number(0)),loop([assignment(var(“i”),
      add(value(var(“i”)),number(1)))],var(“i”),number(11))], _{—} )
4 activate_translator( )
```

The variable situation is finally:

```
STATEMENTLIST1 = [expr(asse(generate(relative_oper(var(var(“i”,0)) ,eq,
    const(i(0)))))),is(do(cs(stmntlist([expr(asse(generate(relative_oper(var(var(“i”,0)),
    eq,math_oper(var(var(“i”,0)),plus,
    const(i(1)))))))])),generate(relative_oper(var(var(“i”,0)),lt,
    const(i(11))))))]
Str = “{ i = 0 ; do { i = i + 1 ; } while ( i < 11 ) ; }”
Str1 = “i = 0 ; do { i = i + 1 ; } while ( i < 11 ) ;”
SList = [“i = 0 ; do { i = i + 1 ; } while ( i < 11 ) ;”]
```

In the final stage, the result of the translator is printed out to the screen using the clause dialog_SetStr, in such a way that the third parameter has the printable value:

1 dialog_setstr( Win, ID, “{i =0 ; do {i =i + 1 ;} while ( i < 11);}”)
2 activate_translator( )

The translation is now complete!

Matrix Principle

Every formal language can be depicted as vectors \overline{X}, \overline{X}={X₁..Xⱼ} and each term can be depicted as elements of the vector. In this case, the underlining depicts the form of the vector. Thus the relationship between two languages and the possible conversions with their terms can be depicted as a relationship between the vectors \overline{X} (input language) and \overline{Y} (target language), which is in practice a matrix. A sensible result is obtained from a translation between the input and target languages, only if at least one semantic solutions, i.e. correspondence, can be found in the target language for each term of the input language, so that the term corresponding to the solution can be applied in the translator and a target-language portion corresponding to it can be printed out later.

The invention is depicted as a conversion between two languages using the matrix formula \overline{Y}=[A]*\overline{X}, in which [A] is a matrix, describing the relation between a vector \overline{X} an a vector \overline{Y}. In practice, the relationship comprises conversion instructions. In one cell Aᵢⱼ of the matrix, there is thus a conversion instruction between an element i of language X and an element j of language Y, if the conversion is possible.

The selection of the matrix according to the input language takes place on the basis of the semantic name (Xᵢ) of the numbered terms, when the index i is defined while selection on the basis of the target language takes place according to the operating connection, when the index j is defined. The operating connection is based on the form of a corresponding occurrence, which is defined when creating a corresponding higher conversion instruction.

For example, when an equivalent to the language X assignment clause assignment(VAR, EXPRESSION) is created in a new language Y, in which there is a corresponding term bind(VAR, EXPRESSION), it is natural to make a connection from the EXPRESSION master terms to the target language's EXPRESSION main term between all their possible occurrences. It is preferable to use the smallest possible number of links between the languages and to select the most natural way to connect the terms to each other. If the link from language to language is defined on some level of the grammar, then in all other links from an input-language term to the new language it is possible to refer to the aforesaid link directly, if the new link is on a higher hierarchy level.

### EXAMPLE

Assume that the input language's EXPRESSION contains three terms and links are needed from it to the master terms EXPRESSION, in which there are five terms and ASSIGNMENT_EXPRESSION, in which there are three terms. If both cases are handled comprehensively, at least six links (3 to both) will be needed in the conversion instruction. If ASSIGNMENT_EXPRESSION is a sub-group of the EXPRESSION term, and the link EXPRESSION->ASSIGNMENT_EXPRESSION has already been defined, it is possible to refer to the conversion instruction get_EXPRESSION_ASSIGNEMENT_EXPRESSION in the link EXPRESSION->EXPRESSION. Thus, only three links are needed to the direct terms and additionally a transfer from the master term EXPRESSION to the master term EXPRESSION.

On the other hand, when a link is created, for example, from the master term EXPRESSION to the master term MATHEMATICAL_EXPRESSION it will only be necessary to define the mathematical clauses of the input language, in relation to the new term.

Using the aforementioned principle, it is also possible to implement multi-language translators, in which one matric is the programming language, matrix [A] and a second matrix [B] is, for example, a data-transfer protocol or an operating system interface or library.

Thus source code according to the Y language is produced, which is the result of the two matrices:
\overline{Y}=[A]*[B]*\overline{X}.

If, in the new interface matrix [B] a cell has a selected value, for example empty, it means that the result of the [A] matrix is used as such in the new source code. If the value of the cell is something else, for example, a type-conversion command, or a text format clause, the corresponding new version is exploited.

Division of the Translation into Several Stages:

The translation can be divided into an infinite number of separate stages, which all exploit the original parsing tree as starting data, but which also receive supplementary data from the preceding stages. For example, the data of the symbol table of the previous stage are used in the following stage, when the object classes are defined and the final code is printed out in the third stage.
\overline{Y}=[A]*[B]*[C]*\overline{X}.
Creating Symbol Tables:

The method is used to create symbol tables, using the X language's parsing tree as starting material as follows. The desired terms of the language are defined as symbol variables in the dialogue or directly in the grammar file. A symbol is created using the name of the master term reserved in the symbol table, for example, VAR signifies the name of the variable and STRUCT the name of the record, i.e. the structure. The definition is made from the grammar as follows: SYMBOLTABLE=VAR -> variable(VAR), STRUCT -> struct(STRUCT).

Thus when the program goes through the parsing tree in the first stage of the conversion, all the variable references are stored in the cache memory in every case where reference is made to VAR or STRUCT type terms. When moving to the generation of a new language, the necessary variable definitions (VAR and STRUCT) are printed out at the relevant point at the start of the method or function in question, or, for example, at the start of the entire program file.

In the following are the grammatical descriptions and files relating to the example, as well as PDL algorithms for creating files automatically. In the PDL description, the words master term corresponds to the word Production, the word term corresponds to the word Term, the word occurrence to the word Subterm, and the word indivisible term to the word Terminal.

| | 2) Descriptive language (Prolog) |
|---|---|
| 1) Input-language X grammar as a formal presentation | conversion |
| The grammar is presented in the form Term name “=” Occurences | |
| Occurrence = Syntax form “->” Semantic_correspondence | |
| PROGRAM = COMMAND* separator dot | |
| COMMAND = | |
| VAR eq EXPRESSION | -> assignment(VAR, EXPRESSION), |
| repeat PROGRAM until VAR It EXPRESSION | -> loop(PROGRAM,VAR,EXPRESSION) |
| EXPRESSION = | |
| EXPRESSION plus EXPRESSION | -> add(EXPRESSION, EXPRESSION) |
| − | |
| VAR | -> value(VAR), |
| number(INTEGER) | -> number(INTEGER) |
| VAR = name(STRING) | -> var(STRING) |

3) X Language Glossary (Reserved Words)

In the example, the reserved words are collected from the grammar, for instance: repeat, until, plus, lt, dot. All the others except repeat and until are interal abbreviations. The words are stored in a file in the form str_tok(“repeat” repeat), in which the right-hand repeat refers to the semantic portion and the left-hand “repeat” to the syntax portion.

The following is the PDL (programming design language) algorithm.

*1 FOR EACH WORD IN GRAMMAR DEFINITION
*2 IF WORD IS A RESERVED WORD (X)
*3 STORE IT INTO GLOSSARY FILE
*4 AND MAKE A STRING str_tok(“X”,X).
str_tok(“.”,dot)
str_tok(“=”,eq)
str_tok(“repeat”,repeat)
str_tok(“until”,until)
str_tok(“<”,lt)
str_tok(“+”,plus)

4) Datatypes of the X Language

The datatypes are collected from the right-hand side of each term: assignment, loop, add, var, number, value.

The following is the PDL (programming design language) algorithm for collecting the datatypes.

```
*FOR EACH TERM AND SUBTERM
  * GET THE RIGHT HAND SIDE (RHS) OF EACH GRAMMAR
  CLAUSE
  * STORE THE RHS INTO GRAMMARS SEMANTICS AND
  INTO DATABASE
```

| | |
|---|---|
| PROGRAM = | COMMAND* |
| COMMAND = | assignment(VAR,EXPRESSION); |
| | loop(PROGRAM,VAR,EXPRESSION) |
| EXPRESSION = | add(EXPRESSION,EXPRESSION); |
| | value(VAR); |
| | number(INTEGER) |
| VAR = | var(STRING) |

5) Scanner Term (Entire Glossary)

The term P_TOK is a collection of all possible language symbols. In the source code, it is information for the scanner. The scanner reads the input file and classifies each word in the file.

The following is the corresponding PDL algorithm.

| *1 FOR EACH TERMINAL IN GRAMMAR DEFINITION | |
|---|---|
| *2 STORE THE TERMINAL INTO P_TOK-DOMAIN | |
| P_TOK | =dot( ); |
| | eq( ); |
| | repeat( ); |
| | until( ); |
| | lt( ); |
| | plus( ); |
| | number(INTEGER); |
| | name(STRING); |
| | nill |

6) X Language Parsing Logic.

The parsing code (in the Prolog language) is developed automatically using the top-down technique. The following is the corresponding PDL-algorithm.

```
*1 USE RECURSIVE DESCENT - METHOD (DIFFERENCE LIST):
  *2 FOR EACH PRODUCTION
  *3 GENERATE A CODE FOR EACH PRODUCTION
  *4 OF FORMAT “s_+ PRODUCTION NAME” WITH LL1 AND LL0 AS PARAMETERS
  *5 AND FOUND PRODUCTION TERMS AS AN OUTPUT PARAMETER.
  *6 CALL PRODUCTION's SUBTERMS IN PROPER ORDER
  *7 RENUMBER LIST TERMS LLn STARTING FROM 1 WITH LL0 as OUTPUT LIST
  *8 FIND TOKENS OF SYNTAX BY A SUITABLE CALL (pexpect)
  *9 COLLECT ALL INFORMATION INTO PARSE TREE WITH STARTSYMBOL AS A ROOT
  *10 GENERATE SUB-PREDICATES FOR EACH SEPARATE PARAMETER COMBINATION
  *11 OF CURRENT PRODUCTION.
```

Highest Level: Program and Command Terms

```
s_program(LL1,LL0,[COMMAND|PROGRAM]):-
    s_command(LL1,LL2,COMMAND),!,
    s_program1(LL2,LL0,PROGRAM).
s_program(LL,LL,[ ]).
s_program1([t(dot,_)|LL1],LL2,PROGRAM):-!,
    s_program(LL1,LL2,PROGRAM).
s_program1(LL,LL,[ ]).
s_command(LL1,LL0,assignment(VAR,EXPRESSION)):-
    s_var(LL1,LL2,VAR),
    pexpect(t(eq,_),LL2,LL3),
    s_expression(LL3,LL0,EXPRESSION),!.
s_command([t(repeat,_)|LL1],LL0,loop(PROGRAM,VAR,
EXPRESSION)):-!,
    s_program(LL1,LL2,PROGRAM),
    pexpect(t(until,_),LL2,LL3),
    s_var(LL3,LL4,VAR),
    pexpect(t(lt,_),LL4,LL5),
    s_expression(LL5,LL0,EXPRESSION).
s_command(LL,_,_):-psyntax_error(command,LL),fail.
```

7) X Langauge Parsing Logic.

Lower level, EXPRESSION and VAR Terms

```
s_expression(LL1,LL0,EXPRESSION):-
    s_expression1(LL1,LL0,EXPRESSION).
s_expression1(LL1,LL0,EXPRESSION_):-
    s_expression2(LL1,LL2,EXPRESSION),
    s_expression3(LL2,LL0,EXPRESSION,EXPRESSION_).
s_expression2(LL1,LL0,value(VAR)):-
    s_var(LL1,LL0,VAR),!.
s_expression2([t(number(INTEGER),_)|LL],LL,number(INTEGER)):-!.
s_expression2(LL,_,_):-psyntax_error(expression2,LL),fail.
s_var([t(name(STRING),_)|LL],LL,Var(STRING)):-!.
s_var(LL,_,_):-psyntax_error(var,LL),fail.
s_expression3([t(plus,_)|LL1],LL0,EXPRESSION,EXPRESSION_):-!,
    s_expression2(LL1,LL2,EXPRESSION1),
    s_expression3(LL2,LL0,add(EXPRESSION,EXPRESSION1),
    EXPRESSION_).
s_expression3(LL,LL,EXPRESSION,EXPRESSION).
```

8) X Language Generating Code

Generating is the opposite operation to parsing. The generating code (in the Prolog language) is constructed from the master term records of the database, in such a way that each term is divided into its occurrences and the final code string (source code to be printed out) is the sum of the sub-terms, which is formatted with the aid of format clauses.

The following is the corresponding PDL algorithm.

*1 FOR EACH PRODUCTION
*2 IF PRODUCTION IS LIST GENERATE A LIST GENERATING
COMMAND
*3 ELSE GENERATE A TERM GENERATING COMMAND
*
*LIST GENERATING COMMAND:
* 1 GENERATE LIST END EVENT: EMPTY LIST -> EMPTY
STRING
* 2 GENERATE LAST EVENT CASE: GENERATE A CALL
FOR CURRENT LIST'S MEMBER
* 3 OTHERWISE: GENERATE A CALL FOR CURRENT LIST'S
MEMBER +
* 4 GENERATE A RECURSIVE LOOP FOR OTHER
MEMBERS OF THE LIST

The program, which is a consecutive list of commands, is collected into a string Str.

```
gen_PROGRAM([ ],””).
gen_PROGRAM([H], Str):- gen_COMMAND(H, Str), !.
gen_PROGRAM([H|T], Str):-
  gen_COMMAND(H, St1), gen_PROGRAM(T, St2),
  format(Str,“%s. %”, St1,St2).
*TERM GENERATING COMMAND:
*1 FOR EACH PRODUCTION
*2 FOR EACH SUBTERM
*3 GENERATE A CLAUSE IN FORMAT
*4 “gen_PRODUCTION(SUBTERM, Str):-” AS A HEAD AND
*5 NUMBERED CALLS OF EACH SUBTERM
PARAMETERS AND
*6 AND PARAMETER OUTPUT STRINGS
CALLED TOGETHER BY
*7 AND SLIST AND gen_output-CALLS.
*8 WHERE Str IS GENERATED SOURCE CODE FOR
CURRENT LANGUAGE
```

The assignment command contains a variable (in this case, its printout form is Str1) and a clause (in this case, its printout form is Str2) and they are added to the formatted string called “command_assignment” using the list Slist. The clause gen_output is retrieved into the format string from the auto_form record, using the same argument.

```
gen_PROGRAM([ ],“”).
  gen_PROGRAM([H], Str):- gen_COMMAND(H, Str), !.
  gen_PROGRAM([H|T], Str):-
    gen_COMMAND(H, St1), gen_PROGRAM(T, St2),
    format(Str,“% . %”, St1,St2).
gen_COMMAND(assignment(VAR1,EXPRESSION2) ,Str):-
    gen_VAR(VAR1,Str1),
    gen_EXPRESSION(EXPRESSION2,Str2),
    SList =[Str1,Str2],
    gen_output(SList, “command_assignment”, Str), !.
gen_COMMAND(loop(PROGRAM1,VAR2,EXPRESSION3) ,Str):-
    gen_PROGRAM(PROGRAM1,Str1),
    gen_VAR(VAR2,Str2),
    gen_EXPRESSION(EXPRESSION3,Str3),
    SList =[Str1,Str2,Str3],
    gen_output(SList, “command_loop”, Str), !.
gen_EXPRESSION(add(EXPRESSION1,EXPRESSION2) ,Str):-
    gen_EXPRESSION(EXPRESSION1,Str1),
    gen_EXPRESSION(EXPRESSION2,Str2),
    SList =[Str1,Str2],
    gen_output(SList, “expression_add”, Str), !.
gen_EXPRESSION(value(VAR1) ,Str):-
    gen_VAR(VAR1,Str1),
    SList =[Str1],
    gen_output(SList, “expression_value”, Str), !.
gen_EXPRESSION(number(INTEGER1) ,Str):-
  str_int(Str1,INTEGER1),
    SList =[Str1],
    gen_output(SList, “expression_number”, Str), !.
gen_VAR(var(STRING1) ,Str):-
    gen_STRING(STRING1,Str1),
    SList =[Str1],
    gen_output(SList, “var_var”, Str), !.
```

Gen_output carried out the final finishing of the clause, using the format clauses.

9) X-Language Format Clauses

The following is the corresponding PDL algorithm.

```
*1 FOR EACH PRODUCTION AND SUBTERM NAME
  *2 GENERATE A FORMAT CLAUSE “auto_form” FROM
  CURRENT SYNTAX WITH
  *3 “%” AS A VARIABLE PLACE AND OPERATOR
  TOKEN AS ITS PLACE
  *4 NAME THE CLAUSE BY A PRODUCTION AND
  SUBTERMNAME AS PARAMETERS
```

The translator developer goes through all the terms in the database and constructs a data record of each one. The record has the form auto_form(Id-string, format-part). The symbol “%” signifying location, is assigned during the generating stage of the variables code. The format clauses are constructed in the opposite sequence from grammar and abbreviations. Thus, the symbols lt, eq, dot are listed. The strings are named in such a way that they have two parts: the master term and an underline “_” and the name of a sub-term (for example, command assignment is “command_assignment”).

auto_form(“command_assignment”,“% = %”).
auto_form(“command_loop”,“repeat % until % < %”).
auto_form(“expression_add”,“% + %”).
auto_form(“expression_value”,“%”).
auto_form(“expression_number”,“%”).
auto_form(“var_var”,“%”).

10) Conversion Table, i.e. Conversion Instructions Created as the Result of Interactive Connection

The get clauses are ready constructed in the interface of the translator developer (FIGS. 3 and 4), which use the following algorithm. PROLOG-language clauses are obtained as the end result.

```
FOR EACH LINK OF FORMAT x(X) -> y(Y)
  GENERATE A GET-CLAUSE of FORMAT get_X_{——}Y(X,Y):-
  SUBCLAUSES !.
    WHERE X AND Y ARE NON-TERMINALS WITH
    PARAMETERS ON NON-TERMINALS
      AND SUBCLAUSES IS A LIST OF LOWER LEVEL
      GET_CLAUSES DERIVED FROM PARAMETER
      COMBINATIONS OF X AND Y.
```

In one interactive processing (manual stage) the result was the following clauses:

```
get_VAR_{——}VARIABLE(var(STRING1), variab(name(STRING1))):- !.
get_COMMAND_{——}STATEMENT(assignment(VAR1,EXPRESSION2),
      assignment_stmnt(assignment(VARIABLE1,Y_EXPRESSION2))):-
  get_VAR_{——}VARIABLE(VAR1,VARIABLE1),
  get_EXPRESSION_{——}EXPRESSION(EXPRESSION2,Y_EXPRESSION2), !.
get_COMMAND_{——}STATEMENT(loop(PROGRAM1,VAR2,EXPRESSION3),
repeat_STMNT(loop(STATEMENTLIST1,less_than(EXPRESSION1,EXPRESSION2)))):-
  get_PROGRAM_{——}STATEMENTLIST(PROGRAM1,STATEMENTLIST1),
  get_VAR_{——}EXPRESSION(VAR2,EXPRESSION1),
  get_EXPRESSION_{——}EXPRESSION(EXPRESSION3,EXPRESSION2), !.
  get_PROGRAM_{——}STATEMENTLIST([ ],[ ]):- !.
  get_PROGRAM_{——}STATEMENTLIST([H1|T1],[H2|T2]):-
    get_COMMAND_{——}STATEMENT(H1, H2), get_PROGRAM_{——}STATEMENTLIST(T1,T2), !.
                            % Default code PROGRAM -> STATEMENTLIST
get_VAR_{——}EXPRESSION(var(STRING1), name_expr(name(STRING1))):- !.
get_EXPRESSION_{——}EXPRESSION(add(EXPRESSION1,EXPRESSION2),
                            add(Y_EXPRESSION1,Y_EXPRESSION2)):-
  get_EXPRESSION_{——}EXPRESSION(EXPRESSION1, Y_EXPRESSION1),
  get_EXPRESSION_{——}EXPRESSION(EXPRESSION2, Y_EXPRESSION2), !.
get_EXPRESSION_{——}EXPRESSION(value(VAR1),name_expr(Y_NAME1)):-
  get_VAR_{——}NAME(VAR1, Y_NAME1), !.
get_EXPRESSION_{——}EXPRESSION(number(INTEGER1), int(INTEGER1)):-!.
get_VAR_{——}NAME(var(STRING1), name(STRING1)):- !.
```

11) Formal presentation of target language Y's grammar 12) Conversion of descriptive language
(Prolog)

PROGRAM =
STATEMENTLIST BLOCK -> program(STATEMENTLIST, BLOCK)
BLOCK = void main lpar ARGLIST rpar COMPOUNDSTMNT

| | |
|---|---|
| | -> main(ARGLIST, COMPOUNDSTMNT), |
| STATEMENTLIST | -> statementlist(STATEMENTLIST) |

STATEMENTLIST = STATEMENT*
STATEMENT =

| | | |
|---|---|---|
| FUNCTION_DEFINITION | semicolon | -> fd(FUNCTION_DEFINITION), |

| | | |
|---|---|---|
| LABELED_ST | semicolon | -> ls(LABELED_ST), |
| COMPOUNDSTMNT | | -> cs(COMPOUNDSTMNT), |
| EXPRESSION | semicolon | -> expr(EXPRESSION), |
| SELECTION_ST | semicolon | -> ss(SELECTION_ST), |
| ITERATION_ST | semicolon | -> is(ITERATION_ST), |
| JUMP_ST | semicolon | -> js(JUMP_ST), |
| DECLARATION | semicolon | -> declare(DECLARATION) |

ITERATION_ST =
do STATEMENT while lpar EXPRESSION rpar

-> do(STATEMENT, EXPRESSION),

while lpar EXPRESSION rpar STATEMENT

-> while(EXPRESSION, STATEMENT),

```
    for lpar EXPRESSIONLIST semicolon EXPRESSIONLIST semicolon EXPRESSIONLIST rpar
            STATEMENT
            -> for(EXPRESSIONLIST, EXPRESSIONLIST, EXPRESSIONLIST, STATEMENT)
ASSIGNMENT_EXPRESSION =
    UNARY_EXPRESSION ASSIGNMENT_OPERATOR ASSIGNMENT_EXPRESSION
    -> ase(UNARY_EXPRESSION, ASSIGNMENT_OPERATOR, ASSIGNMENT_EXPRESSION),
    CONDITIONAL_EXPRESSION
            -> ce(CONDITIONAL_EXPRESSION),
        generate(GENEXPRESSION)
            -> generate(GENEXPRESSION)
GENEXPRESSION =
        GENEXPRESSION questionm GENEXPRESSION
            -> conditional_expr(GENEXPRESSION, GENEXPRESSION)
        GENEXPRESSION LOG_OP GENEXPRESSION
            -> logical_oper(GENEXPRESSION, LOG_OP, GENEXPRESSION)
        GENEXPRESSION MATH_OP GENEXPRESSION
            -> math_oper(GENEXPRESSION, MATH_OP, GENEXPRESSION)
        GENEXPRESSION OP GENEXPRESSION
            -> relative_oper(GENEXPRESSION,OP,GENEXPRESSION)
        name(STRING) lpar EXPRESSIONLIST rpar
            -> function_call(STRING, EXPRESSIONLIST)
```

| | |
|---|---|
| VAR | -> var(VAR), |
| CONSTANT | -> const(CONSTANT) |

ASSIGNMENT_OPERATOR =

| | |
|---|---|
| OP | -> eq(OP), |
| .. | |

| | |
|---|---|
| plus_eq | -> plus_eq, |

| | |
|---|---|
| minus_eq | -> minus_eq |
| OP = | |
| eq | -> eq, |
| ne | -> ne, |
| gt | -> gt, |
| lt | -> lt, |
| ge | -> ge, |
| le | -> le |

13) Y language-glossary

The Y-language glossary is not required,
because the printout takes place using format
clauses.
The following is a sample of the glossary:
str_tok(“;”,semicolon)
str_tok(“,”,comma)
str_tok(“void”,void)
str_tok(“main”,main)
str_tok(“(”,lpar)
str_tok(“)”,rpar)
str_tok(“if”,if_)
str_tok(“else”,else)
str_tok(“do”,do)
str_tok(“while”,while)
str_tok(“for”,for)
str_tok(“=”,eq)
str_tok(“{”,lbr)
str_tok(“}”,rbr)
str_tok(“:”,colon)
str_tok(“case”,case)
str_tok(“default”,default)
str_tok(“switch”,switch)
str_tok(“goto”,goto)
str_tok(“continue”,continue)
str_tok(“break”,break)
str_tok(“return”,return)

14) Y-Language Datatypes:

PROGRAM = program(STATEMENTLIST,BLOCK)
BLOCK = main(ARGLIST,COMPOUNDSTMNT);

stlist(STATEMENTLIST)

MAIN = main(DECLARATOR,ARGLIST)
STATEMENTLIST = STATEMENT*
STATEMENT = fd(FUNCTION_DEFINITION);

ls(LABELED_ST);
cs(COMPOUNDSTMNT);
expr(EXPRESSION);
ss(SELECTION_ST);
is(ITERATION_ST);
js(JUMP_ST);
declare(DECLARATION)

COMPOUNDSTMNT = stmntlist(STATEMENTLIST)

| | |
|---|---|
| SELECTION_ST | = if_else(EXPRESSION,STATEMENT,STATEMENT); |

if_then(EXPRESSION,STATEMENT);
switch(EXPRESSION,STATEMENT)

| | |
|---|---|
| ITERATION_ST | = do(STATEMENT,EXPRESSION); |

while(EXPRESSION,STATEMENT);
for(EXPRESSIONLIST,EXPRESSIONLIST,EXPRESSIONLIST,STATEMENT)

ASSIGNMENT_OPERATOR = eq(OP)
ASSIGNMENT_EXPRESSION =
ase(UNARY_EXPRESSION,ASSIGNMENT_OPERATOR,ASSIGNMENT_EXPRESSION);

ce(CONDITIONAL_EXPRESSION);
generate(GENEXPRESSION)

| | |
|---|---|
| MATH_OP | = plus( ); |

minus( );
mpy( );
div_( )

| | |
|---|---|
| EXPRESSION | = asse(ASSIGNMENT_EXPRESSION); |

ce(CONDITIONAL_EXPRESSION);
generate(GENEXPRESSION)

EQUALITY_EXPRESSION = eq_rel(EQUALITY_EXPRESSION,RELATIONAL_EXPRESSION);

relexp(RELATIONAL_EXPRESSION)

RELATIONAL_EXPRESSION = lt(RELATIONAL_EXPRESSION,SHIFT_EXPRESSION);

gt(RELATIONAL_EXPRESSION,SHIFT_EXPRESSION);
lt_eq(RELATIONAL_EXPRESSION,SHIFT_EXPRESSION);
gt_eq(RELATIONAL_EXPRESSION,SHIFT_EXPRESSION);
sh_exp(SHIFT_EXPRESSION)

SHIFT_EXPRESSION = left(SHIFT_EXPRESSION,ADDITIVE_EXPRESSION);

right(SHIFT_EXPRESSION,ADDITIVE_EXPRESSION);
add_exp(ADDITIVE_EXPRESSION)

ADDITIVE_EXPRESSION = add(ADDITIVE_EXPRESSION,MULTIPLICATIVE_EXPRESSION);

sub(ADDITIVE_EXPRESSION,MULTIPLICATIVE_EXPRESSION);
mult_exp(MULTIPLICATIVE_EXPRESSION)

PRIMARY_EXPRESSION = var_expr(VAR);

const(CONSTANT);
str(STRING,CURSOR);
par_expr(EXPRESSION)

VAR = var(STRING,CURSOR)
CONSTANT = null( );

true_( );
false_( );
ec(ENUMERATION_CONSTANT);
i(INTEGER);
str(STRING)

Scanner terms (Y language)

```
A scanner is not used in the Y language,
because reading takes place in the X language.
The following is a sample of the scanner terms.
P_TOK = semicolon( );
      comma( );
      void( );
      main( );
      lpar( );
      rpar( );
      if_( );
      else( );
      do( );
      while( );
      for( );
      eq( );
      lbr( );
      rbr( );
      colon( );
      case( );
      default( );
      switch( );
      goto( );
      continue( );
      break( );
      number(INTEGER);
      true_( );
      false_( );
      op(OP);
      nill
```

18) Y-Language Parsing Logic

As this is not required in the example, it is not shown.

18) Y-Language Generating Code

The following example gives the necessary code according to the principle of section 8:

```
gen_y_STATEMENTLIST([ ],“”).
gen_y_STATEMENTLIST([H], Str):- gen_y_STATEMENT(H, Str), !.
gen_y_STATEMENTLIST([H|T], Str):-
  gen_y_STATEMENT(H, St1), gen_y_STATEMENTLIST(T, St2), format(Str,“% %”, St1,St2).
gen_y_STATEMENT(cs(COMPOUND_ST1),Str):-
  gen_y_COMPOUND_ST(COMPOUND_ST1 ,Str1),
  SList =[Str1],
  gen_y_output(SList, “statement_cs”, Str), !.
gen_y_STATEMENT(es(EXPRESSION_ST1) ,Str):-
  gen_y_EXPRESSION_ST(EXPRESSION_ST1,Str1),
  SList =[Str1],
  gen_y_output(SList, “statement_es”, Str), !.
gen_y_STATEMENT(is(ITERATION_ST1) ,Str):-
  gen_y_ITERATION_ST(ITERATION_ST1,Str1),
  SList =[Str1],
  gen_y_output(SList, “statement_is”, Str), !.
gen_y_ITERATION_ST(do(STATEMENT1,EXPRESSION2) ,Str):-
  gen_y_STATEMENT(STATEMENT1,Str1),
  gen_y_EXPRESSION(EXPRESSION2,Str2),
  SList =[Str1,Str2],
  gen_y_output(SList, “iteration_st_do”, Str), !.
gen_y_ASSIGNMENT_OPERATOR(eq(OP1) ,Str):-
  gen_y_OP(OP1,Str1),
  SList =[Str1],
  gen_y_output(SList, “assignment_operator_eq”, Str), !.
gen_y_ASSIGNMENT_EXPRESSION(ase(UNARY_EXPRESSION1,
      ASSGNMENT_OPERATOR2,ASSIGNMENT_EXPRESSION3) ,Str):-
  gen_y_UNARY_EXPRESSION(UNARY_EXPRESSION1,Str1),
  gen_y_ASSIGNMENT_OPERATOR(ASSIGNMENT_OPERATOR2,Str2),
  gen_y_ASSIGNMENT_EXPRESSION(ASSIGNMENT_EXPRESSION3,Str3),
  SList =[Str1,Str2,Str3],
  gen_y_output(SList, “assignment_expression_ase”, Str), !.
gen_y_EXPRESSION(asse(ASSIGNMENT_EXPRESSION1) ,Str):-
  gen_y_ASSIGNMENT_EXPRESSION(ASSIGNMENT_EXPRESSION1,Str1),
  SList =[Str1],
  gen_y_output(SList, “expression_asse”, Str), !.
gen_y_VAR(var(STRING1,_) ,Str):-
  gen_y_STRING(STRING1,Str1),
  SList =[Str1],
  gen_y_output(SList, “var_var”, Str), !.
gen_y_CONSTANT(i(INTEGER1) ,Str):-
  str_int(Str1,INTEGER1),
  SList =[Str1],
  gen_y_output(SList, “constant_i”, Str), !.
gen_Y_GENEXPRESSION(math_oper(GENEXPRESSION1,MATH_OP2,
```

GENEXPRESSION3),Str):-

```
  gen_Y_GENEXPRESSION(GENEXPRESSION1,Str1),
  gen_Y_MATH_OP(MATH_OP2,Str2),
  gen_Y_GENEXPRESSION(GENEXPRESSION3,Str3),
  SList =[Str1,Str2,Str3],
  gen_output(SList, “genexpression_math_oper”, Str),
  ! .
gen_Y_GENEXPRESSION(relative_oper(GENEXPRESSION1,OP2,GENEXPRESSION3) ,Str):-
  gen_Y_GENEXPRESSION(GENEXPRESSION1,Str1),
  gen_Y_OP(OP2,Str2),
  gen_Y_GENEXPRESSION(GENEXPRESSION3,Str3),
  SList =[Str1,Str2,Str3],
  gen_output(SList, “genexpression_relative_oper”, Str),
  !.
gen_Y_GENEXPRESSION(var(VAR1) ,Str):-
  gen_Y_VAR(VAR1,Str1),
  SList =[Str1],
  gen_output(SList, “genexpression_var”, Str), !.
gen_Y_GENEXPRESSION(const(CONSTANT1) ,Str):-
  gen_Y_CONSTANT(CONSTANT1,Str1),
  SList =[Str1],
  gen_output(SList, “genexpression_const”, Str), !.
gen_Y_MATH_OP(plus,“+”).
gen_Y_OP(eq,“=”).
```

Below are also the formatting operations that are language-independent (general-purpose tool):

```
gen_output(Slist, Form, Str):-
    auto_form(Form, StrF),
    format_loop(Str, StrF, SList), !.
gen_output(Slist, Form, Str):-
  format(Txt,“\n %:”, Form),
  gen_slist_Str(SList, Txt, Str), !.
gen_output(Slist, Form, Str):-
    not(auto_form(Form, _)),
    gen_slist_Str(SList,“,”,Str).
```

19) Y-Language Format Clauses

The following are samples of the format clauses:

auto_form(“program_program”,“% %”).
auto_form(“block_main”,“void main ( % ) %”).
auto_form(“block_stlist”,“%”).
auto_form(“main_main”,“% main ( % )”).
auto_form(“compoundstmnt_stmntlist”,“{ % }”).
auto_form(“selection_st_if_else”,“if ( % ) % else %”).
auto_form(“selection_st_if_then”,“if ( % ) %”).
auto_form(“selection_st_switch”,“switch ( % ) %”).
auto_form(“iteration_st_do”,“do % while ( % )”).
auto_form(“iteration_st_while”,“while ( % ) %”).
auto_form(“iteration_st_for”,“for ( % ; % ; % ) %”).
auto_form(“assignment_operator_eq”,“%”).
auto_form(“assignment_expression_ase”,“% % %”).
auto_form(“assignment_expression_ce”,“%”).
auto_form(“assignment_expression_generate”,“%”).
auto_form(“genexpression_math_oper”,“% % %”).
auto_form(“genexpression_relative_oper”,“% % %”).
auto_form(“genexpression_var”,“%”).
auto_form(“genexpression_const”,“%”).
auto_form(“expression_asse”,“%”).
auto_form(“expression_ce”,“%”).
auto_form(“expression_generate”,“%”).
auto_form(“constant_expression_cond”,“%”).
auto_form(“relational_expression_lt”,“% < %”).
auto_form(“relational_expression_gt”,“% > %”).
auto_form(“relational_expression_lt_eq”,“% <= %”).
auto_form(“relational_expression_gt_eq”,“% >= %”).
auto_form(“relational_expression_sh_exp”,“%”).

1. A method for developing a translator, which translator is intended to convert input-language code into target-language code, and in which method a descriptive language (v) is used to formally depict two source languages that are independent of each other, that is, the said input language (x) and the target language (y), each source language including formal master terms (Xᵢ, Yⱼ) and in each master term there being one or several occurrences with possible parameters in these, and in which a program framework is formed for the translator, as well as a group of files, which are linked together and translated for the selected operating system, characterized in that the said file are formed in the following stages:
the grammars of both source languages (X and Y) are stored in a selected format in files, in such a way that all the occurrences of the master terms of both languages are itemized (stages 1 and 1′),
descriptive language versions (VX and VY) of both source languages (X and Y) are formed in a database, in which descriptive language each occurrence of a term (VXᵢ, VYⱼ) is stated semantically, with the aid of the selected descriptive language term (Vₖ) and the defined terms of the source language, (stages 2 and 2′),
the accessory files VX(a-e) and VY(a-e), such as for example,
a) glossary and scanner terms
b) datatypes
c) parsing logic
d) generating code
e) format clauses
required for the translator are formed from the descriptive language versions (VX) and (VY) of the input and target languages (VX) and (VY) and from the stored grammars of the source languages (X and Y) (stages 3 and 3′),
the interactive connection of each converted input-language term VXᵢ to the selected target-language term VYₙ is carried out, comprising in steps of (stages 4 and 5):
the connection of the master terms to each other
the matching of the occurrences to each other, and
the conversion instruction (VX[ ]VY) of each converted input-language term (VXᵢ) is stored in a file.

2. A method according to claim 1, characterized in that:
the input language's parsing logic (VX(c)) and
the necessary generating code (VY(d)) of the target language and
the conversion instructions (VX[ ]VY) and
the necessary format clauses (VY(e)) of the target language, are stored in a database or similar for the translator, so that the translator can form, with the aid of the parsing logic (VX(c)) and the code of the input language to be translated, a parsing tree (stage 9) including the code in descriptive language form and convert the code with the aid of the conversion instructions (VX[ ]VY) into descriptive language form (stage 10) and generate and format the descriptive language code into target-language code (stage 11), with the aid of target-language generation and format clauses (VY(d,e)).

3. A method according to claims 1, characterized in that, in the interactive connection, an inference engine is used, which exploits one or more of the following criteria:
the linking of previously connected occurrences is proposed,
the linking of occurrences/parameters having the same name, on the basis of descriptive language terms is proposed,
the linking of parameters on the basis of order is proposed.

4. A method according to any of claims 1, characterized in that the interactive connection is carried out using a graphical interface including at least selection windows for the terms being proposed, for the conversion instructions being formed, as well as at least one pop-up menu window for the selection list, and in which in each selection window each component acts as a link to the corresponding selection list that appears.

5. A method according to any of claims 1, characterized in that the PROLOG language is used as the descriptive language and/or the source language of the translator.

6. A system for translating a computer program from a first source language, i.e. the input language (X), to a second source language, i.e. the target language (Y), which system includes
an input file (7) including several lines of code containing the input-language computer program,
a translator (X>Y) connected to the input file (7), which translator reads the input file and generates a translated version of the computer program, and in which the translator includes conversion instructions (VX[ ]VY, 41) relating to each input-language term,
a translated file (12) connected to the translator (X>Y), for receiving the translated version of the computer program thus generate,
an operation library, containing routines to be called by the translator (X>Y), characterized in that the system also includes:
a first accessory file (VX(c), 31c) containing the input-language parsing logic for the selected semantic descriptive language (V),
a second accessory file (P(Y(d,e), 42), containing the source-language generating and format clauses;
in which case the translator (X>Y) is arranged:
to convert the computer program's lines of code first of all into descriptive language form, using the parsing logic of the first accessory file VX(c), (stage 9); and
then to convert them in descriptive language form, using the said conversion instruction (VX[ ]VY, 41), (stage 10) and
to generate and format the descriptive language code into formal target-language code (stage 11), using the target-language generating code (VY(d), 42) and format clauses (VY(e), 42).

7. A system according to claim 6, characterized in that the target language (Y) is a selected-form documentation format for the automatic documentation of the input-language (X) program.

8. A system according to claim 7, characterized in that the selected-form documentation is a program variable list.

9. A system according to claim 7, characterized in that the selected-form documentation of the input-language (X) program is a cross-reference table.

10. A system according to claim 7, characterized in that the target language (Y) is a selected-form documentation of the input-language (X) program is a data-flow diagram.
